(19) United States
(12) Patent Application Publication
(10) Pub. No.: US 2022/0374808 A1
(43) Pub. Date: Nov. 24, 2022

(54) TASK CONCATENATION AND PREDICTION OF OPERATOR AND SYSTEM RESPONSE IN SOCIO-TECHNICAL SYSTEMS USING ARTIFICIAL INTELLIGENCE

(71) Applicant: FRAIGN ANALYTICS, LLC, St. Louis, MO (US)

(72) Inventor: Saul David ROBINSON, St. Louis, MO (US)

(21) Appl. No.: 17/772,443

(22) PCT Filed: Oct. 30, 2020
(86) PCT No.: PCT/US2020/058332

§ 371 Date: Apr. 27, 2022

Related U.S. Application Data
(60) Provisional application No. 62/927,798, filed on Oct. 30, 2019.
(60) Provisional application No. 62/927,785, filed on Oct. 30, 2019.

(51) Int. Cl. G06Q 10/06

(52) U.S. Cl. CPC G06Q 10/06316

(57) ABSTRACT

A system and method controlling a controlled system receiving operational status message containing actual state operational parameter values from controlled system components, determining a current observed state, a plurality of predetermined objective operational parameters, an operational model, the determining of an optimal state, determining a set of gaps between corresponding components of the observed state and the determined optimal state including an associated value representing the magnitude of the difference, collecting the determined gaps in a gap list, determining the difference values between stored operational thresholds associated with the determined gaps, comparing the associated difference values of the determined gaps with the operational thresholds for the associated controlled component and providing an alert when the comparing of the associated difference values of the determined gaps exceed the received operational threshold.

### CROSS-REFERENCE TO RELATED APPLICATIONS

This application is a Patent Cooperation Treaty (PCT) International Application that claims the benefit of U.S. Provisional Application No. 62/927,785, filed on Oct. 30, 2019, and 62/927,798, filed on Oct. 30, 2019. The disclosures of the above applications are incorporated herein by reference.

### FIELD OF THE INVENTION

The present disclosure relates to training and control systems, and more specifically, to real time human operated feedback systems for improved control and training and methods for each.

### BACKGROUND

The statements in this section merely provide background information related to the present disclosure and may not constitute prior art.

Socio-technical systems (STS) are becoming increasingly more common in modern society. Socio-technical systems relate to the complex interaction between humans and structures and processes that form a single co-dependent system. Advances in Artificial Intelligence, from computer science and electrical engineering, provide the opportunity for more tightly bound and efficient systems.

STSs are known for having the capability to assess and evaluate a given situation, and to provide a computer-generated response to the situation back to a human operator. Due to the adaptable nature, they are becoming popular in many industries, including but not limited to financial, aircraft/airlines, health care, nuclear power, marine, and defense.

STSs are defined herein as a general broad class of systems that comprise hardware, software, processes, or procedures, and a form of human operation or interaction. They are considered to be complex and fast, typically implemented on a high-performance computing (HPC) platform and configured to generate a large quantity and wide variety of information in response to received external stimulus to the system. The information that the STS generates and/or operations that the STS then executes are a result, in whole or in part, of previously observed stimulus and situations and/or can vary based on different components and relationships that make up the STS. The resulting behavior of the STS, due to changes in individual components, is difficult to predict and can typically only be observed through the altered behavior of the system as a whole. Therefore, design and refinement of such systems have proven to be very difficult and expensive.

One common approach to designing STSs is to design a system that is tailored to a type of technology being used, or to a specific application, such as using a STS for automatic control of a specific controlled system or process. However, this application-specific design approach often leads to an inadequate system that often neglects the sensitive relationship between the STS and the operator. The STS can be deficient for its intended purpose, since a human-in-the-loop operator reveals valuable information that can be used to continuously refine the system design. Furthermore, by the time information related to a human operator is introduced, the system can already be quite mature for its original intent. Consequently, having to redirect or change the design and development process to address the human operator component can require significant changes late in the design process, resulting in significant redesign and cost increases.

Computer-based learning STSs, whether they are neural-network, deep learning, or machine learning types, can be “trained” to respond in a manner equivalent to a human operator of the system. As STSs have progressed through the years, removing and isolating human operators from the system has been emphasized in order to reduce human-based operational error. However, without the human interface with these STSs, new types of errors have emerged as a result of isolated operator awareness and control over the system.

As identified by the inventor hereof, maintaining the human interaction with the system is extremely beneficial for real world applications where human-in-the-loop response is unavoidable or is required. In view of this and other shortcomings of prior STSs, the presently disclosed STS and method maintains the human-in-the-loop operator interaction into the STS. The STS is configured to “learn” from human-in-the-loop operator responses to various system operational situations. The improved STS can then use these responses in a variety of ways, including for task concatenation, workload assessment, operator response prediction, educational training needs identification, by way of examples, which solves the limitations of the current system and can provide for the design and implementation of an STS that enables human-in-the-loop interaction with the capability to learn and adapt to the human responses in a way that is easier to implement at reduced costs.

### BRIEF SUMMARY

The present disclosure is of a STS that maintains the human operator in-the-loop status for controlling a controlled system or process and for improved operator training. This type of system has many uses and benefits over prior art STSs. The present system and method are directed to a STS that utilizes deep learning methods to aid and interactively train a STS operator for improved performance thereof. The present system and method provide for monitoring and evaluating the workload of the operator when operating a particular scenario based on comparisons to more experienced operators and their respective operational profiles. Based on the monitored and learned human operator response, the system and method tracks human operator control inputs to the operational system and compares them to stored inputs for similar system operational tasks as previously received from other and often more experienced operators, such as from operators with a greater level of skill at particular tasks. The system and method utilizes this information and evaluates the relative workload of the operator, generates a list of tasks, presents the list to the operator, thereby allowing the operator to select to have the activities completed by the STS based on past operational profiles stored in the system from that which were received from the other and often more experienced operators. In some circumstances, the system can utilize the information in the trained models to automatically execute the tasks that are required for operating the controlled system/process. This system and process will be described herein with reference to an aircraft as the controlled system. However, it should be noted that this is an exemplary embodiment and is not intended to be limiting.

According to one aspect, a control system for managing the operational tasks of a controlled system that has a controlled interface module for receiving and transmitting information with the controlled system. The system also has a human interface module for receiving inputs from a human operator and a communications module for communicating information with a human operator. The system also has a processor module, a system memory module for storing computer executable instructions, a memory module for random access memory (RAM) storage during system operation, and a high performance computing (HPC) module. The processor module is configured for processing of computer executable instructions that facilitate the flow of information between the controlled system, the operator, the system memory module, the RAM, and the HPC module. The control system includes an input for receiving at least one operational status message containing an operational parameter having one or more operational parameter values representative of the actual state of an operation of the controlled system from at least one of the controlled system components of the controlled system during operation thereof. The system processes the received operational parameter and the one or more operational parameter values to determine a current observed state of the controlled system or controlled component of the system. The system also has at least one operational model of the controlled system stored in the system memory module, each at least one operational model including a plurality of predetermined objective operational parameters associated with one or more operational components of the controlled system and has at least one objective parameter value for one or more of the plurality of the predetermined operational parameters. The processor is configured to access the memory and retrieve the at least one operational model, and to determine an optimal state of the controlled system or controlled system component as a function of the retrieved operational profile and the received operational status message. The observed state and the optimal state of the controlled system each have a plurality of operational components, the actual state information and optimal state information of the operational components each have a corresponding match. The operational components have an associated measured operational value representing the state of the operational component. The processor being configured to, upon determining the observed state information of the controlled system and determining the optimal state of the controlled system, further determining a set of gaps between corresponding components of the observed state and the determined optimal state of the controlled system. These determined gaps include an associated value representing the magnitude of the difference between the observed state and the optimal state. The processor is configured for collecting the determined gaps in a gap list that represents the differences between the observed state and the optimal state of the controlled system. The processor further retrieves from the memory one or more stored operational thresholds associated with the determined gaps and that correspond to one or more of the controlled components of the controlled system. The retrieved operational thresholds are indicative of an acceptable range of difference values between the matched controlled components of the observed state and the determined optimal state. The processor is configured for comparing the associated difference values of the determined gaps with the received operational thresholds for the associated controlled component and providing an alert to the human operator when the comparing of the associated difference values of the determined gaps exceed the received operational threshold for one or more of the associated controlled components.

According to another aspect, a control system is disclosed for assisting a human operator with operational task execution of a controlled system with a plurality of controlled components. The system has a human interface module for receiving and communicating with a human operator, a memory module for storing artificial computer executable instructions, and a processor module configured for processing of computer executable instructions for managing the system controlled information. A HPC module is provided for complex computational processing, and a controlled system interface module is configured for receiving and transmitting information messages to the controlled components of the controlled system. The control system includes an operational model of the controlled system stored in the memory module with the operational model having information that represents a plurality of component operational models matched to the plurality of controlled components. The information is configured to generate modeled operational behavior of the components with a generated value indicative of the modeled observed state of the components upon receipt of input information messages containing one or more values for one or more operational parameters of an actual state of one or more controlled components of the controlled system via the controlled system interface module. The modeled operational components collectively model the operation of the controlled system. The processing module is configured with computer executable instructions for determining observed state information of the controlled system or one or more controlled components thereof. The observed state information includes measured values that are indicative of an actual state of the controlled components of the controlled system. The processing module is also configured for receiving an operator profile from the memory of the operator's operational behaviors and operational tendencies. It is further configured for predicting one or more operator inputs as a function of the observed state and the stored operator profile including one or more operational behaviors and tendencies. It is also configured for determining a predicted state model of the controlled system, that includes a plurality of predicted states and a most likely predicted state thereof. This determining of the predicted state model is a function of the determined observed state as the initial state, the predicted one or more operator inputs and the plurality of component operational models. The determined predicted state model includes a plurality of determined predicted states as a function of the predicted operator inputs, with each predicted state model including a most likely predicted state.

According to yet another aspect, a control method is provided for prioritizing operational tasks associated with operating a controlled system. The method includes retrieving flight profile information from a memory module and generating an optimal operational profile and a sequence of optimal states from the flight profile information based on sequences of states of controlled system components. The method also includes receiving operational component state information from one or more controlled components of the controlled system having operational parameters and values for operational parameters representative of an actual state of the controlled system. After that, the method includes determining an observed state of the controlled system based on the received operational component state information and the received flight profile information, comparing the observed state with a sequence of the generated sequence of optimal states and identifying the most likely alignment in time within the sequence, and generating a list of gaps that exist between the determined observed state and the generated optimal state. The method further includes receiving executed tasks associated with the actual state of the controlled system during the retrieving of the operational component state information and evaluating the received tasks that are in the optimal state according to the determined optimal operational profile. The method also includes determining tasks required for the controlled system to perform to reduce the gaps between the actual state and the optimal state, and aggregating the determined tasks into a task list and establishing a measure of criticality associated with each determined task based on the observed state relative to a stored activation threshold for such a task by which the task must be completed. The method further includes generating over an output interface to an operator of the controlled system the determined task list and a task selection prompt providing the operator with selectable task options from which the operator can select as an operator task input, and monitoring the observed state of one or more operational parameter values for determining when and activation threshold is being approached. The method also includes executing one or more tasks automatically when the monitoring determines that the activation threshold is being approached, and generating an alert to the operator over an output interface prompting the operator to provide a control input as to one or more of the tasks on the task list for which the control system cannot automatically generate as a function of the operational profile for the controlled system.

Further aspects of the present invention will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a block diagram of a system and the direction of information message transmission between components and sub-components of a social-technical system (STS) for controlling an external system, which in this exemplary embodiment is an aircraft.

FIG. 2 is an operational flow diagram of the initiation process of the STS of an exemplary embodiment for an aircraft.

FIG. 3 is an operational flow diagram of a STS process for interacting with a controlled system of an exemplary embodiment for an aircraft in the in-flight mode of operation.

FIG. 4 is an operational flow diagram of a STS for comparing live operation information to operational model information of an exemplary embodiment for an aircraft in the in-flight mode of operation.

FIG. 5 is an operational flow diagram of a STS for engaging, transmitting information to, and receiving information from a high-performance computing module of an exemplary embodiment for an aircraft in the in-flight mode of operation.

FIG. 6 is a behavioral model diagram of a STS of an exemplary embodiment for an aircraft in the in-flight mode of operation.

FIG. 7 is a timing diagram of actors and interactions of a STS of an exemplary embodiment for an aircraft in the in-flight mode of operation.

FIG. 8 including FIGS. 8A, 8B, 8C, 8D, and 8E, is an operational flow diagram of predictive and automatic execution aspects of the present disclosure of an exemplary embodiment for an aircraft in the in-flight mode of operation.

FIG. 9 is an operational flow diagram of an application method for determining a state of a controlled system of an exemplary embodiment for an aircraft in the in-flight mode of operation.

FIG. 10 is an example display of a task list that is presented to an operator of an exemplary embodiment for an aircraft in the in-flight mode of operation.

FIG. 11 is an operational flow diagram of a STS for an exemplary embodiment of an aircraft in the instructional mode of operation.

FIG. 12 including 12A and 12B, is an operational flow diagram of a STS for an exemplary embodiment of an aircraft in the model training mode of operation.

Corresponding reference numerals will be used throughout several figures of the drawings.

### DETAILED DESCRIPTION

The following detailed description illustrates the presently disclosed system and method by way of example and not by way of limitation. The present disclosure includes reference to an exemplary embodiment in the aviation field, with reference to an aircraft operator, an improved system for training the aircraft operator, and a control system for controlling of the aircraft in cooperation with the aircraft operator. However, after reviewing this disclosure, one skilled in the art of artificial intelligence, training systems and control systems will be capable of making and using the described system or method, adaptations, variations, and alternatives thereof in a multitude of fields. Additionally, it is to be understood that the described system and method is not limited in its application to the details of construction and the arrangements of components set forth in the following description or illustrated in the drawings. Various embodiments of the described system and method are capable of other embodiments and of being practiced or being carried out in various ways.

It is to be understood that the phraseology and terminology used herein is for the purpose of description and should not be regarded as limiting. The word “training” is used throughout this detailed description. It should be noted that the term “training” as used herein has two possible meanings. The first meaning applies to the field of artificial intelligence, machine learning, and deep learning or collectively called a “trained model” and generally is identified as “AI training”. The second meaning applies to “training” in an educational or instructional sense, such as operator or user training as identified herein generally as “operational training”.

A ‘model’ can include several members, including, but not limited to, functional relationships, component models, operational parameters (also referred herein in shortened form as just a “parameter” which is intended to mean operational parameter unless otherwise stated), and profiles. These can include specific functional relationships that can be defined, by way of example, by one or more equations, tables, diagrams, and flow charts. The functional relationships can define for each what is a received input value or input information message from a related component, use of such to generate an output value to another related components, an output message, or a response message. Component models define in instructions or rules, by way of examples, how a component of the top-level model will behave, operate, and exchange information with other components in simulation.

Operational parameters define specific operational characteristics of the controlled system or a controlled component and characterize each by one or more predefined and measured operational parameter values that represent an operational aspect within the top-level model. By way of example, the airspeed of an aircraft. The profiles represent the operation of the model with respect to each operational parameter and can include past time sequences of the measured values of a particular operational parameter that represent the operation of the model with respect to that operational parameter under particular operational situations and at various times including past, predicted and currently observed times. By way of example, each operational parameter of a model can further include one or more past operational profiles associated therewith, and each component of a model can have one or more operational parameters associated with the component, with each operational parameter having one or more associated profiles with one or more measured values representative of the component's operation. As such, the model hierarchy includes a top-level ‘model’ having a plurality of model members that includes, functional relationship members, component model members, operational parameter members, with the latter having one or more operational profile members.

In the field of artificial intelligence, machine learning, and deep learning, a model can be viewed as a computer-based behavioral representation of a physical system or state that it represents. In an exemplary embodiment and mode of enablement of the present disclosure is in reference to the field of aviation, and more specifically, aircraft-controlled operation. In such an embodiment, a model for the aircraft refers to a computer-based representation of how the aircraft will operate and behave in simulation in response to external stimulus of a live or simulated scenario. The external stimulus is provided in as input to the model, where it is received by the functional relationships defined in the model to generate an output operational parameter. The output operational parameter can also be received by the functional relationships of component models, thereby generating an output operational parameter of the component model. Associated with each operational parameter is a plurality of operational profiles that represent how the operational parameter behaves or should behave in response to each specific predefined external stimulus or set of stimuli.

In reference to some AI trained models, the word ‘model’ and ‘profile’ often appear to be used interchangeably. However, as previously described, herein a ‘model’ includes many members, which include the dynamic members of the functional relationships and the associated output operational parameters, as well as the one or more ‘fixed’ or substantially fixed members, such as the past operational profiles associated with the operational parameters. The operational profile refers to fixed profile that represents past time sequences of operational parameters as they have varied by the inputs to the functional relationships.

References to ‘operational models’, ‘operational model information’, ‘operational profiles’, and ‘operational profile information’ are discussed throughout the specification. The references to ‘operational models’ and ‘operational model information’ refer to the top-level models as described. The references to ‘operational profiles’ and ‘operational profile information’ refer to the profile members of the operational model as described.

References to ‘flight profiles’, ‘operator profiles’, ‘component models’, and ‘environmental models’ are included throughout the specification. These models and profiles have the same general hierarchical structure as described with reference to the top-level model. In general, ‘flight profiles’ represent the ideal operational profile of a controlled system and will typically be used to determine an optimal state of the controlled system. An ‘operator profile’ includes experience level and skill level, as well as past flight profiles that were generated by the operator. The ‘component models’ each include a plurality of ‘operational profiles’ that can represent the ideal operational profile for the component.

In one embodiment, the presently disclosed is a control system for managing the operational tasks of a controlled system that has a controlled interface module for receiving and transmitting information with the controlled system. The system also has a human interface module for receiving inputs from a human operator and a communications module for communicating information with a human operator. The system also has a processor module, a system memory module for storing computer executable instructions, a memory module for random access memory (RAM) storage during system operation, and a high performance computing (HPC) module. The processor module is configured for processing of computer executable instructions that facilitate the flow of information between the controlled system, the operator, the system memory module, the RAM, and the HPC module.

The control system includes an input for receiving at least one operational status message containing an operational parameter having one or more operational parameter values representative of the actual state of an operation of the controlled system from at least one of the controlled system components of the controlled system during operation thereof. The system processes the received operational parameter and the one or more operational parameter values to determine a current observed state of the controlled system or controlled component of the system. The system also has at least one operational model of the controlled system stored in the system memory module, each at least one operational model including a plurality of predetermined objective operational parameters associated with one or more operational components of the controlled system and has at least one objective parameter value for one or more of the plurality of the predetermined operational parameters.

The processor is configured to access the memory and retrieve the at least one operational model, and to determine an optimal state of the controlled system or controlled system component as a function of the retrieved operational profile and the received operational status message. The observed state and the optimal state of the controlled system each having a plurality of operational components, the actual state information and optimal state information operational components that each have a corresponding match. The operational components have an associated measured operational value representing the state of the operational component. The processor being configured to, upon determining the observed state information of the controlled system and determining the optimal state of the controlled system, further determining a set of gaps between corresponding components of the observed state and the determined optimal state of the controlled system. These determined gaps include an associated value representing the magnitude of the difference between the observed state and the optimal state. The processor is configured for collecting the determined gaps in a gap list that represents the differences between the observed state and the optimal state of the controlled system.

The processor further retrieves from the memory one or more stored operational thresholds associated with the determined gaps and that correspond to one or more of the controlled components of the controlled system. The retrieved operational thresholds are indicative of an acceptable range of difference values between the matched controlled components of the observed state and the determined optimal state. The processor is configured for comparing the associated difference values of the determined gaps with the received operational thresholds for the associated controlled component and providing an alert to the human operator when the comparing of the associated difference values of the determined gaps exceed the received operational threshold for one or more of the associated controlled component.

In some embodiments, the system is further configured to communicate the determined gap list to the operator of the controlled system via the communication module, and in some such embodiment, each operational model includes one or more operational profiles indicative of past optimized operational profiles, and a set of operational tasks that had previously been executed associated with the optimized operational profiles. These can also include in some embodiments, the system generating an optimized task list associated with the past optimized operational profiles and in some implementations, the converting of the gap list into an actual task list, the comparing of the actual task list to the optimized task list and the determining of a difference task list as a function of the comparing. Further, is some embodiments, the system is configured to prioritize the tasks within the difference task list; and to create a prioritized task list from the prioritized tasks, with created prioritized task list aligns the observed state of the controlled system closer with the optimal state of the controlled system. In some embodiments, the communication module further comprises an output terminal configured to present the prioritized task list to the human operator of the controlled system via the output terminal.

In some embodiments, the system is further configured to convert the determined gaps on the gap list into a set of tasks on a task list. This can include a determination that when the difference values exceed the operational threshold associated with a task. The system can be configured to determine whether the associated tasks on the task list can be automatically addressed by the system or the associated tasks must be presented to the human operator for human operator input response. In some embodiments, an output terminal of the system is provided and where the system cannot address one or more of the tasks on the task list, the system is configured to provide an alert over the output terminal to the human operator on a continuous interval. This continuous interval, in some embodiments can be in the range between about 1 s and about 5 s.

In some embodiments, the control system is configured for storing a set of activation thresholds associated with the determined gaps that correspond to the components of the controlled system. These activation thresholds can represent a maximum acceptable difference value between the matched components of the observed state information and the optimal state information. The system can be configured to determine that when the difference values exceed the activation thresholds, the system automatically generates a set of determined control messages to one or more controlled components of the controlled system and generates such until the difference value between the matched components is reduced below a predetermined difference.

In another embodiments, a control system is disclosed for assisting a human operator with operational task execution of a controlled system with a plurality of controlled components. The system has a human interface module for receiving and communicating with a human operator, a memory module for storing artificial computer executable instructions, and a processor module configured for processing of computer executable instructions for managing the system controlled information. A HPC module is provided for complex computational processing, and a controlled system interface module is configured for receiving and transmitting information messages to the controlled components of the controlled system.

The control system includes an operational model of the controlled system stored in the memory module with the operational model having information that represents a plurality of component operational models matched to the plurality of controlled components. The information is configured to generate modeled operational behavior of the components with a generated value indicative of the modeled observed state of the components upon receipt of input information messages containing one or more values for one or more operational parameters of an actual state of one or more controlled components of the controlled system via the controlled system interface module. The modeled operational components collectively model the operation of the controlled system.

The processing module is configured with computer executable instructions for determining observed state information of the controlled system or one or more controlled components thereof. The observed state information includes measured values that are indicative of an actual state of the controlled components of the controlled system. The processing module is also configured for receiving an operator profile from the memory of the operator's operational behaviors and operational tendencies. It is further configured for predicting one or more operator inputs as a function of the observed state and the stored operator profile including one or more operational behaviors and tendencies. It is also configured for determining a predicted state model of the controlled system that includes a plurality of predicted states which includes a most likely predicted state thereof. This determining of the predicted state model is a function of the determined observed state as the initial state, the predicted one or more operator inputs and the plurality of component operational models. The determined predicted state model includes a plurality of determined predicted states as a function of the predicted operator inputs, with each predicted state model including a most likely predicted state.

In some such embodiments, the system further includes an output terminal. The system is configured for determining the predicted state model, including the most likely predicted state, and then generating a presentation of at least some or all of the predicted state model to the operator via the output terminal. In some such embodiments, following the generation of the presentation of the predicted state model to the operator, the processor is configured to generate one or more prompt predicted states as options to the operator from which the operator can select one of the predicted states as an objective state. This can include receiving a selection by the operator of one of the prompted predicted states, and in response, automatically adjusting the controlled system component inputs to the received selected state.

In some embodiments, in response to the generation of the one or more prompts to the operator, the system is configured to determine that the system has not received an operator selection within a predetermined operator response time, and when such is determined, to automatically select the most likely predicted state as an objective state, and to automatically generate one or more control messages to one or more controlled components as a function of the difference between the observed state and the objective state.

In some embodiments, the system is further configured with a flight profile of the controlled system stored in the memory module with such including operational parameters and one or more values of such parameters that represents the plurality of objective states matched to the plurality of controlled components, the operational parameters and values of the parameters including a trendline of past measured parameter values in a time sequence of measured parameter values of the controlled components. The flight profile can represent a predetermined objective operational profile. The processor, in some embodiments, is configured for determining an optimal state of the controlled system, with the determined optimal state including measured parameter values indicative of an optimal state of the controlled components of the controlled system. The controlled components collectively can be representative of an optimal state of the controlled system. The processor can be configured for determining when the operator does not select one of the plurality of generated predicted states within a predetermined time, and in response, automatically selecting one of the plurality of predicted states that most closely aligns with the determined optimal state as an objective state. When such determination is made, the processor can be configured for automatically generating a control message to adjust and operation of one or more of the controlled system components until the observed state is equal to or substantially similar to the optimal state.

In some embodiments, the system is configured to have a flight profile of the controlled system stored in the memory module that includes operational parameters and values for one or more operational parameters that represents one or more optimal states matched to the plurality of controlled components. This information can include a trendline of past measured operational parameter values in a time sequence of measured operational parameter values of the controlled components, with the flight profile representing a fixed ideal operational profile. The processor can be configured for determining optimal state information of the controlled system with the optimal state information having measured parameter values for one or more operational parameters that are indicative of an optimal state of the controlled components of the controlled system, where the controlled components collectively representing an optimal state of the controlled system. The processor can be configured for automatically selecting one of the plurality of predicted states that most closely aligns with the optimal state as an objective state, and automatically generating one or more control messages to one or more controlled system components for adjusting the controlled system component towards the optimal state.

In some embodiments, a control method if provided for prioritizing operational tasks associated with operating a controlled system. The method includes retrieving a flight profile information from a memory module and generating an optimal operational profile and a sequence of optimal states from the flight profile information based on sequences of states of controlled system components.

The method also includes receiving operational component state information from one or more controlled components of the controlled system having operational parameters and values for operational parameters representative of an actual state of the controlled system. After that, the method includes determining an observed state of the controlled system based on the received operational component state information and the received flight profile information, comparing the observed state with a sequence of the generated sequence of optimal states and identifying most likely alignment in time within the sequence, and generating a list of gaps that exist between the determined observed state and the generated optimal state.

The method further includes receiving executed tasks associated with the actual state of the controlled system during the retrieving of the operational component state information and evaluating the received tasks that are in the optimal state according to the determined optimal operational profile. The method also includes determining which tasks are required for the controlled system to perform to reduce the gaps between the actual state and the optimal state, and aggregating the determined tasks into a task list and establishing a measure of criticality associated with each determined task based on the observed state relative to a stored activation threshold for such a task by which the task must be completed.

The method further includes generating over an output interface to an operator of the controlled system the determined task list and a task selection prompt providing the operator with selectable task options from which the operator can select as an operator task input, and monitoring the observed state or one or more operational parameter values for determining when and activation threshold is being approached. The method also includes executing one or more tasks automatically when the monitoring determines that the activation threshold is being approached, and generating an alert to the operator over an output interface prompting the operator to provide a control input as to one or more tasks on the task list for which the control system cannot automatically generate as a function of the operational profile for the controlled system.

In some embodiments of the control method, the method includes retrieving an operator profile that includes past flight profiles as operated by an operator associated with the operator profile and wherein the operator profile includes one or more operator operational behaviors and tendencies. The method can also include predicting a set of operator input responses of the operator as a function of the operational behaviors and tendencies of the operator profile, and prioritizing the operator response inputs based on a determining for each a likelihood that the operator would provide a response input thereof and predicting a set of predicted states from the operator responses.

The process can also include determining tasks required for the controlled system to address the gaps between the actual state and the optimal state. In some embodiments this can include aggregating the tasks into a task list, the tasks determined by selecting one of the predicted states that most closely aligns with the optimal state. The method can also include selecting the tasks associated with the selected predicted state, determining a measure of criticality of danger to passengers, crew, the operator, and the controlled system, and prioritizing the selected tasks associated with the selected predicted state as a function of the determined measure of criticality of danger.

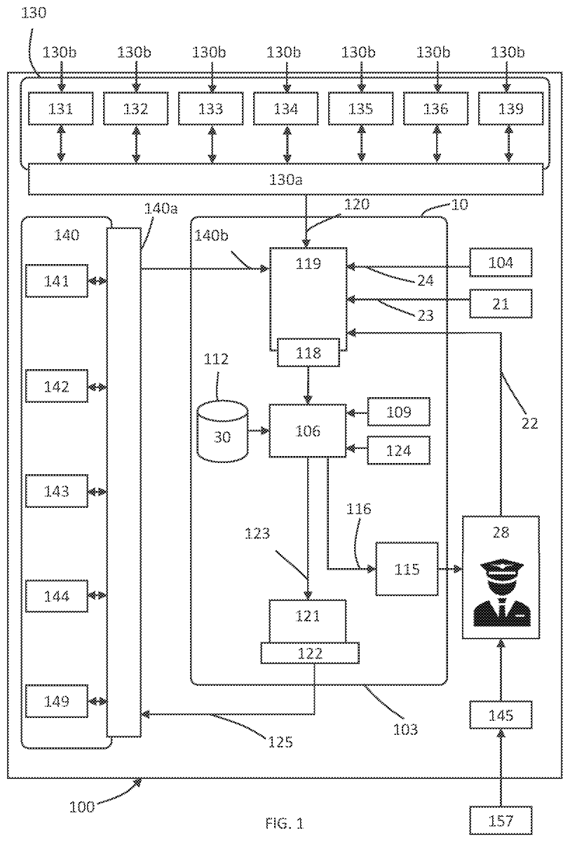

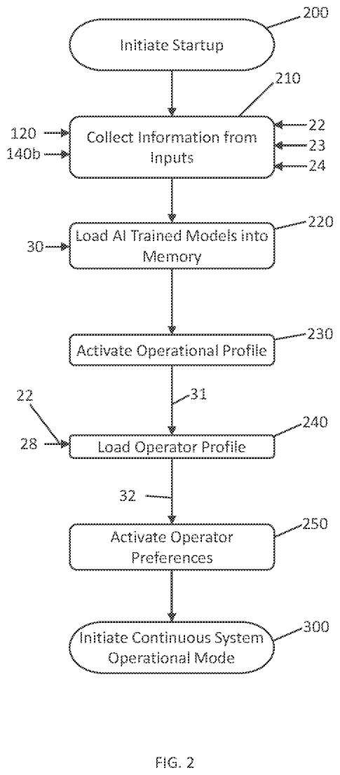

Now with reference to the Figures, referring first to FIG. 1, an aircraft system 100 includes a social-technical system (STS) 10 of the present disclosure that comprises physical components, operational components, computer-based components, and behavior components that are configured to interact internally and with an operator 28 in real-time across several modes of operation.

In a typical implementation, the STS 10 of the present application is configured having a central computing system or central computer 103 with hardware components, at least one software component with computer executable instructions, an operator input 22, and a multitude of peripheral interfaces 119, 122 for receiving input information messages 120, 140b from and transmitting information messages 125 to external monitored and controlled subsystems 130, 140 and with the operator 28 and the environment on the controlled system 100. The STS 10 is typically executed on a central computer 103 with an HPC module 124, although a variety of platforms, including a cloud platform can also be used as determined by the specific controlled system 100 and the needs of the specific application. Throughout this specification, a reference to the STS 10 can imply a computing-based platform configured to execute software applications of the STS 10, the computing-based platform can include an HPC module 124 for high-performance computing. In any case, the system is configured to facilitate communication between the controlled system 100 and the components and modules required for proper operation.

The operator input 22 may be referred to as the human input, the operator interface, human interface, or human interaction components. Additionally, the ‘input’ may come in the form of a ‘response’, and therefore, ‘input’ and ‘response’ may be used interchangeably when interacting with the STS 10. The use of ‘information messages’ may simply be referred to as ‘input’, in particular, in reference to the peripheral interfaces 119, 122. Reference character 119 refers to the input interface 119, whereas reference character 122 refers to the output interface 122, providing receipt of input messages 120, 140b and providing outputs 125, respectively. As noted, these input messages 120 typically are control operator inputs 22 wherein the human operator 28 is providing a control command to the controlled system 100 for controlling one or more of the controlled components 140 thereof.

In an exemplary embodiment, FIG. 1 illustrates the STS 10 implemented in an aircraft system 100 as the controlled system 100. Throughout this specification, ‘aircraft’, ‘aircraft system’, and ‘controlled system’ may be used interchangeably with reference character ‘100’. The aircraft system 100 comprises a central computing system 103, herein referred to as the central computer 103, with all of the main computer components, including a central processing unit (CPU) 106, random access memory (RAM) 109, system non-transitory memory, hard drives, or databases 112, user output terminal 115, system input module 118 connected to input interfaces 119, system output module 121 connected to output interfaces 122, and a specialized high-performance computing (HPC) module 124.

The central computer 103 is configured with computer executable instructions typically in software or firmware for executing all functions of the STS 10. It is configured with an input module 118 that is configured to receive input information messages 120 from situational awareness components or subsystems 130 via the situational awareness component interface 130a, the input information messages including measured values that represent the state of each component. The input module 118 includes a plurality of input interfaces 119 that receive the input information messages 120 via transmission means such as cables or wireless transmission. The input module 118 is configured to interpret the input information messages 120 and convert them into a usable format by the CPU 106. The input module 118 also receives input from additional sources, such as, operator inputs 22, crew and passenger input 23, or system administrator input 24.

The situational awareness components 130 may include, but are not limited to weather information 131, Global Positioning System information 132, radar information, 133, satellite information 134, air data computer systems 135, additional data links 136, and potential future system 139. The situational awareness components 130 are each configured to receive information messages 130b from external to the aircraft system, the information messages 130b including measured values that represent the state of each component. Each situational awareness component 130 is configured to interpret the corresponding information messages and to transmit the information message 120 to the input interface 119 of the input module 118, via the situational awareness component interface 130a.

The CPU 106 is selected from commercially available CPUs and is configured with computer executable instructions to execute a multitude of functions, including receiving the converted input information messages 120, 140b from the input module 118, creating, storing, updating, and retrieving trained models 30 from the system memory 112, utilizing the RAM 109 for dynamic data storage and retrieval as the STS 10 operates, transmitting information including trained models 30 to the HPC module 124, transmitting system control information messages 123 to the output module 121, and transmitting graphical information 116 to be displayed on the output terminal 115.

The output module 121 receives control information messages 123 from the CPU 106 and converts the control information messages 123 into output information messages 125. The output information messages 125 are transmitted to a plurality of controlled system components 140 that collectively operate the controlled system 100. The controlled system components 140 include but are not limited to electronic and hydraulic landing gear 141, environmental systems 142, flight management system 143, powerplant system 144, or other systems 149 required for proper operation of the aircraft system 100, each of the controlled system components 140 including a measured value that represents the state of the component. The controlled system components 140 include a controlled system component interface 140a for interpreting and transmitting the information in the correct format to each controlled system component 140, the correct format including a measured value that represents the state of the component 140. The controlled system component interface 140a is configured to receive a status message containing current observed status information, such as a value for a component operational parameter from one or more of the controlled components 140 and transmitting controlled system component 140 current or observed status as input information messages 140b to the input interface 119 where it is received by the input module 118.

The output terminal 115 is configured to receive the graphical information 116 from the CPU 106 and display the graphical information 116 to the operator 28. In some embodiments, the graphical information 116 can include a corresponding audio ALERT message.

The aircraft system 100 input interface 119 receives information messages 120, 140b from components 130, 140, both internal and external to the controlled system 100, that collectively operate the controlled system 100. The controlled system 100 components 140 can include the components that can be automatically controlled by the central computer 103 or the system operator 28. The external situational awareness components 130 include input information messages 130b to the aircraft 100 and can be configured by the operator 28 for format displayed via the output terminal 115. Human-in-the-loop is maintained by the human input 22 via the input interface 119, while external communications is maintained by the communications link 145, which enables the operator 28 to communicate with air traffic control 157, for example, to receive instructions about the location to land, or other directives. The operator 28 provides an input control message to the aircraft system 100 by providing operator input 22 to the central computer 103 through the input module 118 via the input interface 119. Information messages 140b that identify the state of the aircraft system 100 can be perceived by the operator 28 through an output terminal 115.

In one exemplary embodiment, the central computer 103 is responsible for automatically executing control tasks of the aircraft system 100. It is configured to gather operator input 22, passenger and crew input 23, system administrator input 24, situational awareness information message messages 120, and controlled system input information messages 140b. The inputs 22, 23, 24, 120, 140b are received by the input module 118 via the input interface 119, where they are interpreted and converted to appropriate CPU 106 instructions. In one embodiment as illustrated in FIG. 1, CPU 106 operations include, but are not limited to, controlled system 100 state storage and retrieval in the system memory 112 or RAM 109, managing the communication with and operation of the HPC module 124, which includes, but is not limited to, the ability load trained models 30 from system memory 112 and to transmit them to the HPC module 124, transmit graphical information 116 to the output terminal 115 to display the information to the operator 28, transmit control information messages 123 to the output module 121 where it is converted to output information messages 125 and transmitted to the controlled system components 140 via the output interface 122. The operational STS 10 relies on the CPU 106 to transmit trained models 30 and other input 22, 23, 24, 120, 140b, upon appropriate format conversion, to the HPC module 124.

The HPC module 124 is a specialized component configured for high performance computing applications, including artificial intelligence (AI), deep learning (DL), signal processing, and image processing. The HPC module 124 can be selected from any of the many commercially available high-performance computing platforms, such as a graphics processing unit (GPU), or the like, although a custom design can also be selected. Typical HPC modules 124 can execute in excess of 1000 parallel computing tasks, and thus are especially well-suited for handling the magnitude of calculations required for typical AI and DL applications, thus making an HPC module 124 ideal for the prediction, estimation, optimization, and automatic execution of tasks of the controlled system 100 on behalf of the operator 28.

The HPC module 124 communicates with the CPU 106 and includes appropriate hardware and software components that are responsible for executing high performance computing activities, thereby configured to receive converted controlled system component 140 operational state information messages 140b, converted situational awareness information messages 120, converted operator input 22, crew and passenger input 23, system administrator input 24, as well as AI trained models 30. Upon receipt of the inputs, the HPC module 124 is configured to execute application specific tasks that provides for predicting and estimating controlled system 100 states, assessing differences between current and optimal controlled system 100 states, concatenating required tasks to be executed, as well as providing feedback and recommended activities to the operator 28 of the controlled system 100, and to provide, in some embodiment, control messages 123 to one or more of the controlled systems 140, via the CPU 106 and the output module 121.

The modes of operation of the STS 10 can include an active mode, an instructional mode, and a model training mode. Within these modes of operation, the STS 10 is configured to activate several types of AI trained models 30, each type of AI trained model 30 representing behavioral characteristics of a component 130, 140 or a situation that it represents. The types of trained models 30 that may be activated include operational profiles 31, operator profiles 32, flight profiles 33, controlled system component operational profiles 34, environmental profiles 35 and others as identified necessary. Reference character “30” refers to all generic trained models, while specific reference characters in the thirties will refer to specific trained models. Note that the trained models 30 that are active depends on the mode of operation, the scenario within that mode, and the application at the time of use. Generally, at least one AI trained model 30 will be active during any mode of operation. The controlled system component operational profiles 34 may refer to the top-level controlled system 100, or any of the subcomponents 130, 140 of the controlled system.

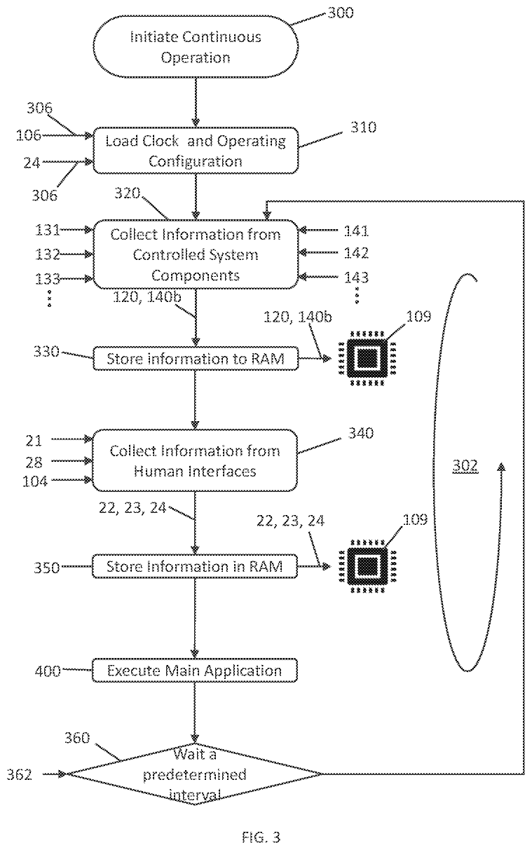

In the active state, the STS 10 is configured to implement the behavioral characteristics of any AI trained model 30 during the active or instructional modes of operation or updating the behavioral characteristics of the AI trained model 30 during the training mode of operation. The STS 10 uses different predefined algorithms to implement the AI trained models 30 in each of the modes of operation. FIG. 2 illustrates one exemplary operational flow of an STS 10 at initial startup, prior to a continuous in-flight mode of operation.

Task 200: Initiate startup activities.

Task 210: Collect information from controlled subsystems input information messages 140b, situational awareness information messages 120 and human inputs 22, 23, 24 via the input interface 119.

Task 220: Based on information from situational awareness information messages 120 and controlled subsystem information messages 140b, load appropriate AI trained models 30 from system memory 112 into RAM 109 via the CPU 106.

Task 230: Activate an operational profile 31 for the controlled system 100.

Task 240: Based on operator input 22, load an operator profile 32.

Task 250: Activate information inputs based on information from the operational profile 31.

Task 300: Initiate continuous mode of operation.

The active and instructional modes of operation include an operator input 22 aspect during continuous operation, while the model training mode of operation can or cannot include a human interaction aspect. The details of the STS 10 and its components, modes of operation, models 30, and details of the interactions will be described herein.

In the exemplary embodiment of FIG. 3, the STS 10 is configured to gather operator input 22, passenger and crew input 23, situational awareness information messages 120, and controlled subsystem input information messages 140b via the input interface 119 by the following operational flow.

Task 300: Initiate continuous mode of operation.

Task 310: Implement a clock-controlled loop 302. Load operating configuration and collect 310 the clock inputs 306 which can be configured by a system administrator input 24, but typically the time step is based on the operating clock of the CPU 106.

Task 320: Collect information messages 120, 140b from each of the situational awareness components 130 and the controlled system components 140, respectively.

Task 330: Store the information messages 120, 140b in RAM 109 for later access, labeled as controlled system information.

Task 340: Retrieve human input information messages from operator input 22, passenger and crew input 23, or system administrator input 24.

Task 350: Store the human input 22 in RAM 109 for later access, appropriately labeled as operator inputs 22, passenger and crew input 23, and system administrator input 24, respectively.

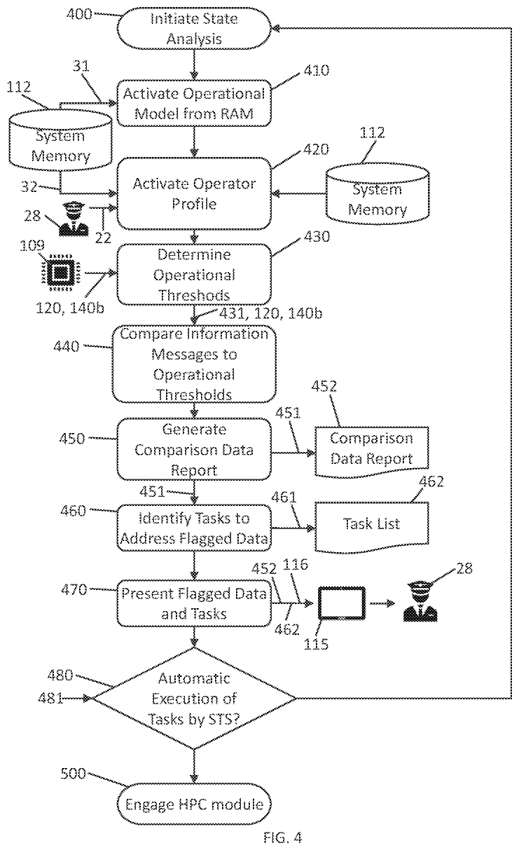

Task 400: Execute main operational applications discussed in FIG. 4.

Task 360: Wait a predetermined amount of time 362, before returning to 320. The amount of time will likely vary by application and configuration but has been found in some embodiments to be between about 1 ms and about 50 ms, which are based on clock speed configuration.

The STS 10 stores and accesses data from RAM 109 about system state via situational awareness information messages 120 and controlled system component information messages 140b each time data is collected from the controlled system component interface 140a or the operator inputs 22. When executing applications, the STS 10 is configured to access data from system memory 112 or RAM 109 as needed based on the main operational application.

In one exemplary embodiment, FIG. 4 shows the operational flow of the STS 10 as it executes state analyses as the main operational application.

Task 400: Initiate state analysis process.

Task 410: Load an operational model 31 from system memory 112 for the controlled system 100 based on controlled system information messages 120, 140b gathered from the controlled system 100.

Task 420: Load operator profile 32 for the operator 28 from system memory 112 based on human inputs 22 to the controlled system 100.

Task 430: Determine operational thresholds 431 from controlled system information messages 120, 140b in RAM 109. Some operational thresholds 431 can be configured by the system administrator 104 or can be included in an AI trained model 34 for the controlled system components 140.

Task 440: Compare actual data from controlled system information messages 120, 140b to operational thresholds 431. The data that is compared is dependent on the specific application at or during the time of operation.

Task 450: Generate a comparison data 451 report 452 with flags assigned to the comparison data 451 where action is needed where the comparison data 451 violates the operational thresholds 431.

Task 460: Determine tasks 461 required to address flagged comparison data 451. Aggregate the tasks into a task list 462, such as a text document or a table in a spreadsheet that is capable of being displayed to the operator 28 via the output terminal 115.

Task 470: Present resulting comparison data report 452 and the task list 462 to operator 28 via graphical information 116 on the output terminal 115.

Task 480: Wait a predetermined amount of time 481 to determine if tasks have been addressed. The amount of time is based on a measure of criticality of the task but is typically between about 1 s and about 10 s. The measure of criticality is previously configured by the system administrator 104 and has a value of low′, ‘medium’, or ‘high’ based on the level of perceived danger to the passengers and crew 21, operator 28, and aircraft 100. If tasks 461 have not been addressed, determine if operational thresholds 431 have been violated. If one or more of the operational thresholds 431 has been violated, engage HPC module 124 and communication management algorithm 500. If not, return to 400.

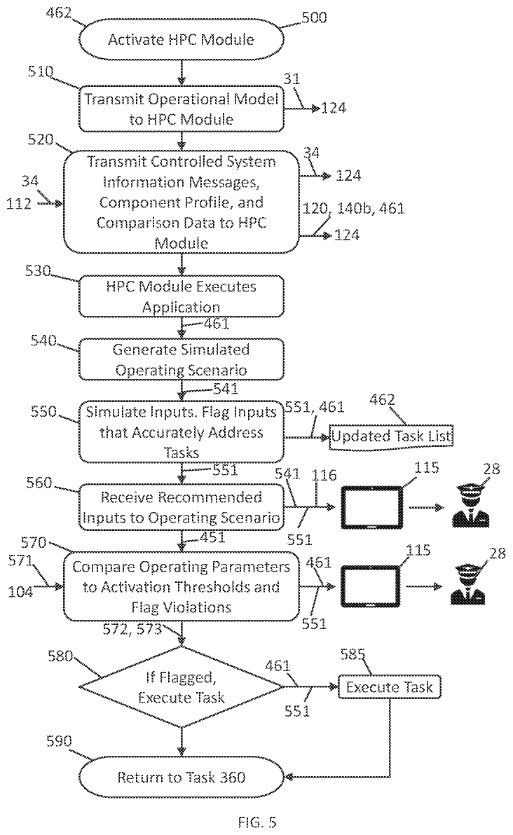

The STS 10 communicates with the HPC module 124 during the computationally intensive algorithms, such as those that predict future controlled system 100 states or those that execute tasks 461 on the task list 462. FIG. 5 shows the algorithm that the STS 10 uses to engage the HPC module 124.

Task 500: If the task list 462 indicates advanced processing is needed, activate the HPC module 124.

Task 510: Transmit the learned operational model 31 to the HPC module 124.

Task 520: Transmit the situational awareness 130 and controlled system component 140 information messages 120, 140b, and the stored operational profile for each of the controlled components 34 to the HPC module 124.

Task 530: Execute an application in the HPC module 124 as a function of the tasks 461, the state of the situational awareness 130 and controlled system components 140, the controlled component profiles 34.

Task 540: Generate a simulated operating scenario 541 based on the information messages 120, 140b, the specific application, and the tasks 461 to be addressed. The operating scenario 541 generated is a computer-based simulation of the live operating scenario 541.

Task 550: Simulate operator inputs 22 in the simulated operating scenario 541 to address each task 461 in the task list 462. Flag the operator inputs 22 that most accurately address each task 461 as recommended inputs 551.

Task 560: Receive operating scenario 541 recommended inputs 551 from HPC module 124, present the operating scenario 541 and recommended inputs 551 to the operator 28.

Task 570: Compare the information in the comparison data 451 to a set of activation thresholds 571 as previously received from a system administrator 104 and stored in the system memory 112 to create an activation message 572, including an activation flag 573. Present flagged tasks 461 with recommended inputs 551 to the operator 28 via the output terminal 115. The activation threshold 571 represents the maximum acceptable difference between actual data from the controlled system 100 and the operational threshold 431.

Task 580: If activation message 572 is flagged 573, the STS 10 takes action 585 on a particular task 461 associated with the activation flag 573. An example of a task 461 that is flagged 573 as being in violation of an activation threshold 571 is for the deployment of landing gear 141 on an approach to a runway. The landing gear 141 needs to be deployed before an altitude floor is breached. Feedback from the altimeter can be received by the STS 10 and flagged as requiring activation. Then, the STS 10 relies on the trained AI models 30 to determine the appropriate task 461, alert the operator 28, and take automatic action if needed.

Task 590: Upon completion of task 580 or 585, respectively, return to task 360.

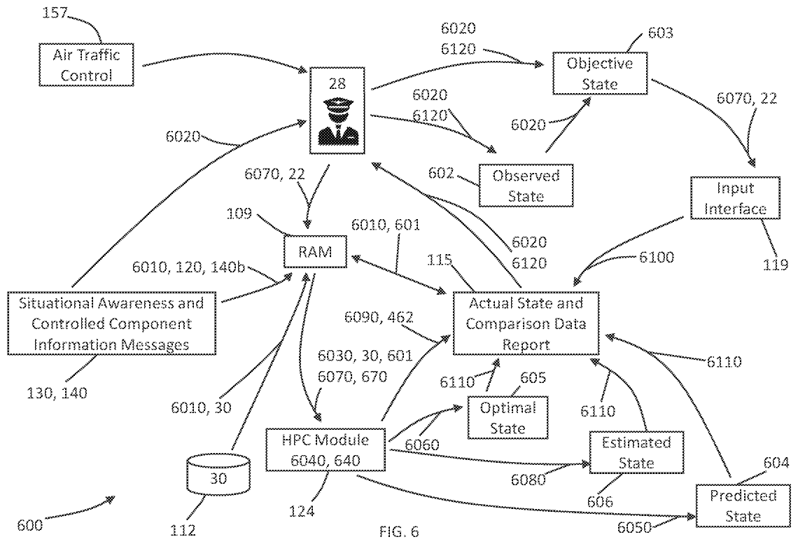

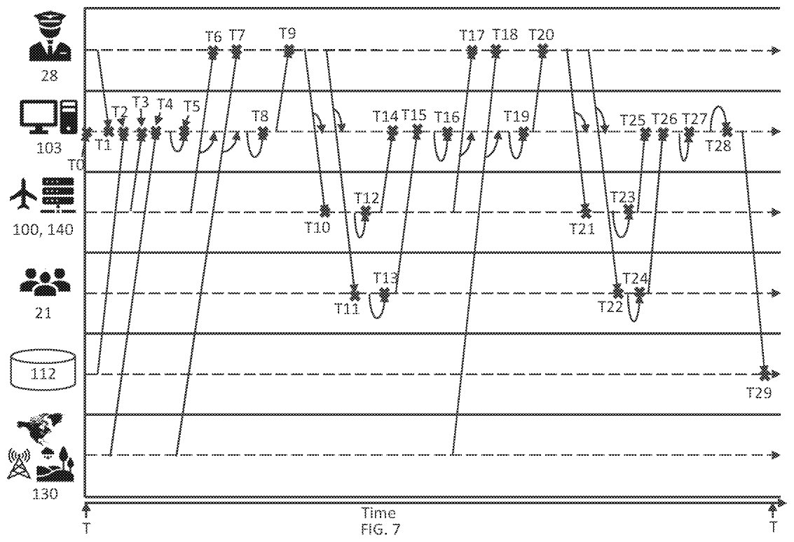

The active mode of operation occurs when an operator 28 is actively using and interacting with the STS 10 for its intended control purpose. In an exemplary embodiment where an aircraft represents the controlled system 100, this mode occurs when the STS 10 is active on an in-flight aircraft with a human pilot as the operator 28. As shown in FIG. 6, the behavior of the STS 10 in this mode of operation includes physical systems as described with reference to FIG. 1, various system states, inputs 22, 23, 24, 120, 140b, communication and data transfer links input messages 130b, 145, feedback loops, operating software, and a human-in-the-loop operator 28.

The STS 10 is configured in this embodiment for tracking and managing the various operational states associated with the aircraft 100 relative to operator inputs 22. STS 10 operation is facilitated through a series of interactions and feedback loops that exchange information messages 120, 130b, 140b between controlled system components 130, 140, central computer 103, and the operator 28 of the aircraft 100. The operational states under consideration in this exemplary embodiment can include the ‘Actual State’ 601, the ‘Observed State’ 602, the ‘Objective State’ 603, the ‘Predicted State’ 604, the ‘Optimal State’ 605, and ‘Estimated State’ 606.

The ‘Actual State’ 601 represents the state of the aircraft 100 as it is captured in the system memory 112, RAM 109, or the HPC module 124 of the central computer 103. The ‘Actual State’ will be displayed on the output terminal 115.

The ‘Observed State’ 602 represents the state of the aircraft 100 from the viewpoint of the operator 28.

The ‘Objective State’ 603 represents the state in which the operator 28 is actively pursuing for the aircraft 100 and is captured through the operator inputs 22 to the aircraft 100 control panel based on the operators 28 ‘Observed

State’ 602.

The ‘Predicted State’ 604 represents a variety of potential states that the aircraft 100 can realize based on responses that applications executing on the HPC module 124 predict, as per information in the operator profile 32.

The ‘Optimal State’ 605 represents an ‘Objective State’ 603 as generated by the HPC module 124 when executing the operational profiles 31. The operational profiles 31 are generated based on flight profiles 33 from past experienced operators 28 in similar scenarios that conform with acceptable operational ranges and policies and procedures. The flight profiles 33 can include information associated with tasks 461 that have been addressed by the operator 28 with an associated timestamp and can include aggregated task lists 461 with associated time stamps. The task lists 461 of optimized flight profiles 33 represent an optimized task list 462 that should be followed for achieving the optimal state 605 of the controlled system 100.

The ‘Estimated State’ 606 is a STS-generated projection of a future ‘Actual State’ 601 based on inputs 22, 23, 24, 120, 140b to the STS 10, and the ‘Actual State’ 601.

It should be noted that each of the exemplary operational states are regularly updated in operational software, and in the perception of the operator 28, in a time sequence with predetermined time steps that are designed to characterize the aircraft 100 operation and its response times to various operator inputs 22 and controlled system component information messages 140b. As the STS 10 operates, the various operational states are tracked and stored in RAM 109 or system memory 112 where it can be accessed during the AI model 30 training mode to update operational models 31, flight profiles 33, operator profiles 32, and other types of models 30 and information.

The STS 10 general behavioral model 600 can be characterized with reference to FIG. 6. The general behavioral model 600 takes advantage of the HPC module 124 that provides for faster execution than possible by human inputs 22, and therefore, for steps that appear to operate in parallel, the central computer 103 operations execute to those operations initiated by human input 22.

Step 6010: Controlled system component information messages 140b, situational awareness information messages 120, and relevant stored models 30 are ingested into RAM 109, where an estimated ‘Actual State’ 601 of the aircraft 100 is generated and presented to the operator 28. A set of fixed inputs for estimating future states of the aircraft 100 can also be determined after loading the operational profiles 31 and the component operational profiles 34 from system memory 112 into RAM 109.

Step 6020: The operator 28 observes the actual state 601 of the aircraft 100 as determined by the situational awareness information messages 120, and the controlled system component information messages 140b on the output terminal 115, thus creating an initial ‘Observed State’ 602 and ‘Objective State’ 603.

Step 6030: The information messages 120, 140b, and AI trained models 30 are loaded from RAM 109 into the HPC module 124.

Step 6040: The HPC module 124 uses operator behavior tendencies, experience, and skill level from the operator profile 32 to predict a probability distribution of predicted operator responses 640 that will be logged to the operator profile 32.

Step 6050: The HPC module 124 uses the ‘Actual State’ 601 and the predicted operator responses 640 to generate a set of ‘Predicted States’ 604 associated with the predicted operator responses 640. The ‘Predicted States’ 604 are logged for operational profile 31 refinement.

Step 6060: The HPC module 124 operates to provide an estimate ‘Optimal State’ 605 based on the ‘Actual State’ 601 and past flight profiles 33 of similar aircraft in a similar state. The ‘Optimal State’ 605 is for flight profile 33 refinement.

Step 6070: The operator 28 responds, thereby providing operator input 22 to the input interface 119, to the ‘Observed State’ 602 towards a ‘Objective State’ 603. The operator input 22 is logged for operator profile 32 refinement.

Step 6080: The HPC module 124 uses the ‘Actual State’ 601 and the operator input 22 to generate an ‘Estimated State’ 606. The ‘Estimated State’ 606 is logged for flight profile 33 refinement.

Step 6090: The HPC module 124 determines the difference between the ‘Optimal State’ 605 and the ‘Estimated State’ 606 and identifies a concatenated task list 462 of tasks 461 to be executed in order to adjust the ‘Estimated State’ 606 closer to the ‘Optimal State’ 605. The task list 462 is displayed to the operator 28 on the output terminal 115 and is logged for operator profile 32 refinement.

Step 6100: The aircraft 100 responds to the operator inputs 22 to the input interface 119 based on the operators 28 ‘Objective State’ 603, resulting in an updated ‘Actual State’ 601. The updated ‘Actual State’ 601 is displayed on the output terminal 115. The ‘Actual State’ 601 is logged for flight profile 33 and operational profile 31 refinement.

Step 6110: The central computer 103 receives the ‘Estimated State’ 606, the ‘Optimal State’ 605, and the ‘Predicted States’ 604 and displays them on the output terminal 115 for the operator 28 to observe.

Step 6120: The operator 28 observes the output terminal 115, thereby, updating the ‘Observed State’ 602 and the ‘Objective State’ 603.

Step 6130: Return to task 6040.

The behavioral model 600 is implemented on the central computer 103 comprising hardware and software components and models, and a human-in-the-loop interface which includes the output terminal 115 and the input interface 119 that facilitates the human perception of graphical information 116 and operator inputs 22 to the STS 10 through a series of tasks 461 that are executed as a function of time. As such, the behavioral model 600 can be further divided and represented by a series information exchanges to characterize the behavioral model 600 in further detail.

With reference to FIG. 7, the actors in the STS 10 includes the operator 28, the central computer 103, the aircraft system 100 and its internal systems, the crew and passengers 21, AI trained models 30, and the operating scenario 541. Note that an aircraft system 100 comprises many physical components 130, 140. Each physical component 130, 140 can have a corresponding component model 34 that simulates the behavior of the physical component 130, 140 in simulation similarly to the actual physical component 130, 140. As such, the HPC module 124 of the central computer 103 is configured to perform parallel high-speed calculations that simulate the operation and interaction among these components 130, 140, the impact of the input information messages 120, 140b from the controlled system components 130, 140, as well as the operator input 22, passenger and crew input 23, and system administrator input 24. The HPC module 124 is configured to simulate the interactions, information exchanges, and responses, and to send simulated output information messages 125 that represent control information messages 123 via the output interface 122 to the associated controlled systems components 140. An exemplary time sequence of these interactions and information exchanges generally occurs in the following time steps along timeline T-T. Each ‘X’ along timeline T-T refers to a timestamp in the timing sequence below.

T0: The STS 10 is powered on by the operator 28 or by the start-up of an aircraft 100. The STS 10 is initialized.

T1: The operator 28 logs into the STS 10.

T2: AI trained models 30 are ingested into RAM 109, then into the HPC module 124.

T3: Controlled system 100 and controlled system component 140 information messages 140b are retrieved by the STS 10.

T4: Situational Awareness component 130 information messages 130b are retrieved by the STS 10.

T5: The STS 10 initializes and logs the operating scenario 541.

T6: The operator 28 perceives the information messages 140b from the controlled system 100 and subsystems 140. The information messages 140b are logged for AI trained model 30 refinement.

T7: The operator 28 perceives the information messages 120 from the situational awareness subsystems 130. The information messages 120 are logged for AI trained model 30 refinement.

T8: The STS 10 utilizes the information messages 120, 140b to determine an actual state 601, predicted state 604, optimal state 605, and estimated state 606. The STS 10 determines the gaps between the optimal state 605, and the most likely predicted state 604, and determines a set of tasks 461 that must be executed to adjust the actual state 601, the estimated state 606, the most likely predicted state 604 towards the optimal state 605 and assembles the gaps into a gap list. The STS 10 then generates a task list 462 of tasks 461 that are required to adjust the actual state 601, predicted state 604, and the estimated state 606 closer to the optimal state 605 thereby addressing the gap list. The states are logged for AI trained model 30 refinement.

T9: The STS 10 displays graphical information 116 representative of the state information 601, 604, 605, 606 and the task list 462 on the output terminal 115, including the most likely predicted state 604. The operator 28 observes the state information 601, 604, 605, 606 and task list 462 on the output terminal 115, thereby creating an observed state 602 and the objective state 603.

T10: Upon observing the state information 601, 604, 605, 606 and task list 462 on the output terminal 115, the operator 28 provides a response input 22 to the input interface 119 indicative of the objective state 603. The operator inputs 22 are logged for operator profile 32 and operational profile 31 refinement. Note that the operator 28 can select not to provide any additional input 22, in which case, the STS 10 assumes the operator 28 intends to have the STS 10 control the controlled system 100 towards the most likely predicted state 604. Alternatively, the STS 10 can be configured to control the controlled system 10 towards the predicted state 604 that aligns most closely with the optimal state 605.

T11: Upon observing the state information 601, 604, 605, 606 and task list 462 on the output terminal 115, the operator 28 can provide additional information to the crew and passengers 21. The additional information is logged for operator profile 32 and operational profile 31 refinement.

T12: The operator inputs 22 provided by the operator 28 to the input interface 119 are ingested by the input module 118, processed and converted into output messages 125 via the output module 121 and transmitted to the controlled subsystems 140 via the output interface 122 where the subsystems 140 are updated.

T13: Passengers and crew 21 provide a response 23 to operator information.

T14: Log output messages 125 for AI trained model 30 refinement.

T15: Log passenger and crew response input response 23.

T16: The STS 10 receives the output messages 125 and the passenger and crew inputs 23 to update the actual state 601.

T17: The operator 28 observes the actual state 601 information messages 140b of the controlled system 100 and the subsystems 140. The actual state 601 information messages 140b are logged for updating the predicted state 604 and the estimated state 606.

T18: The operator 28 observes the actual state 601 information messages 120 of the situational awareness subsystems 130. The actual state 601 information messages 120 are logged for updating the predicted state 604 and the estimated state 606.

T19: The STS 10 utilizes the information messages 120, 140b to determine an actual state 601, predicted state 604, optimal state 605, and estimated state 606. The STS 10 determines the gaps between the optimal state 605, and the most likely predicted state 604, and determines a set of tasks 461 that must be executed to adjust the actual state 601, the estimated state 606, the most likely predicted state 604 towards the optimal state 605 and assembles the gaps into a gap list. The STS 10 then generates a task list 462 of tasks 461 that are required to adjust the actual state 601, predicted state 604, and the estimated state 606 closer to the optimal state 605 thereby addressing the gap list. The states are logged for AI trained model 30 refinement.

T20: The STS 10 displays updated graphical information 116 representative of the state information 601, 604, 605, 606 and the task list 462 on the output terminal 115, including the updated most likely predicted state 604. The operator 28 observes the updated state information 601, 604, 605, 606 and task list 462 on the output terminal 115, thereby creating an updated observed state 602 and updated objective state 603.

T21: Upon observing the updated state information 601, 604, 605, 606 and task list 462 on the output terminal 115, the operator 28 provides a new response input 22 to the input interface 119 indicative of a new objective state 603. The operator inputs 22 are logged for operator profile 32 and operational profile 31 refinement.

T22: Upon observing the updated state information 601, 604, 605, 606 and task list 462 on the output terminal 115, the operator 28 can provide additional information to the crew and passengers 21. The additional information is logged for operator profile 32 and operational profile 31 refinement.

T23: The operator inputs 22 provided by the operator 28 to the input interface 119 are ingested by the input module 118, processed and converted into output messages 125 via the output module 121 and transmitted to the controlled subsystems 140 via the output interface 122 where the subsystems 140 are updated.

T24: Passengers and crew 21 provide a response 23 to operator information.

T25: Log output messages 125 for AI trained model 30 refinement.

T26: Log passenger and crew input response 23.

T27: The STS 10 receives the output messages 125 and the passenger and crew responses 23 to update the actual state 601.

T28: The STS 10 aggregates the logged inputs 22, 23, 120, 140b from the controlled system 100 and subsystems 140, the situational awareness subsystems 130, the operator 28, and the passengers and crew 21 into a usable format for updating the AI trained models 30. The inputs 22, 23, 120, 140b can be logged in either a simple text file or in a spreadsheet with the capability to log timestamps and other relevant information that can be presented to the operator 28.

T29: The STS 10 stores the logged inputs 22, 23, 120, 140b in the system memory 112.

In some embodiments, during STS 10 operation, the STS 10 can intermittently receive interrupts from crew and passengers 21, system administrators 104, or air-traffic control 157. Additionally, the operator 28 can provide a response 22 at any time to interrupt the trajectory of the controlled system 100 as presented on the output terminal 115 to address tasks 461 on the task list 462 or to adjust the actual state 601 towards an optimal state 605. If any of the tasks 461 on the task list 462 are not addressed prior to violation of an activation threshold 571, the STS 10 can be configured to intervene automatically to address the tasks 461 or to provide an ALERT to the operator 28.

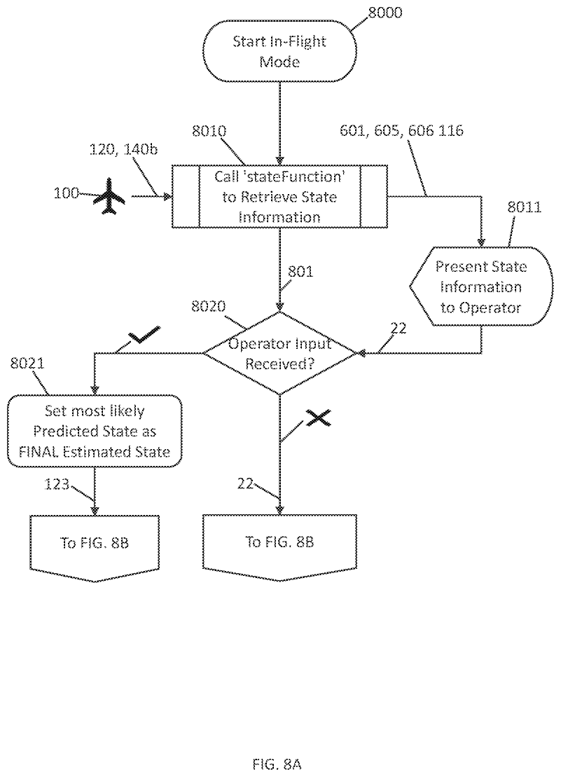

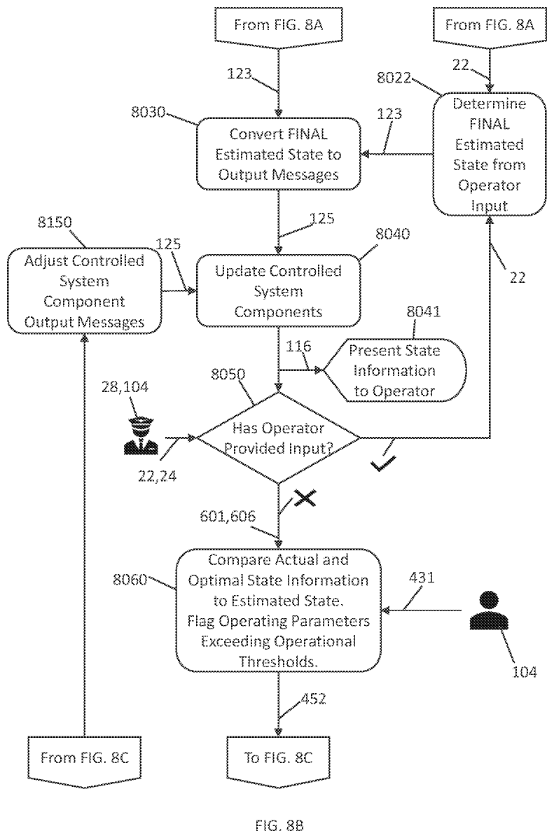

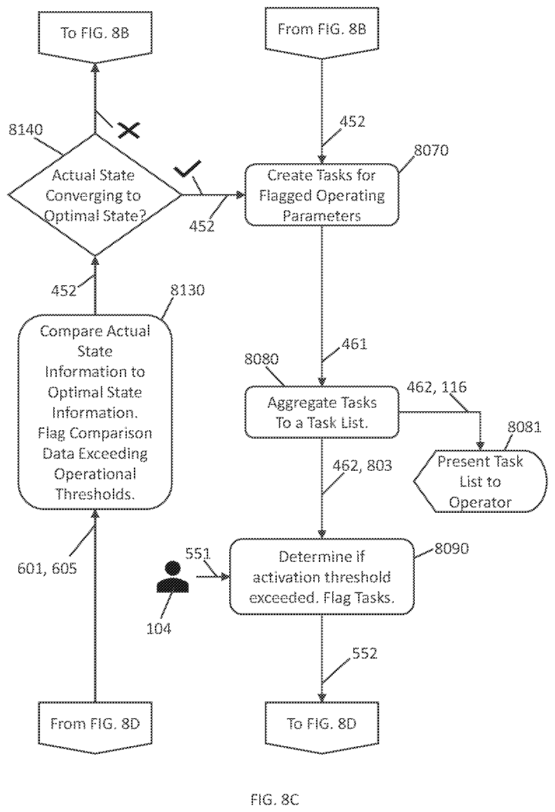

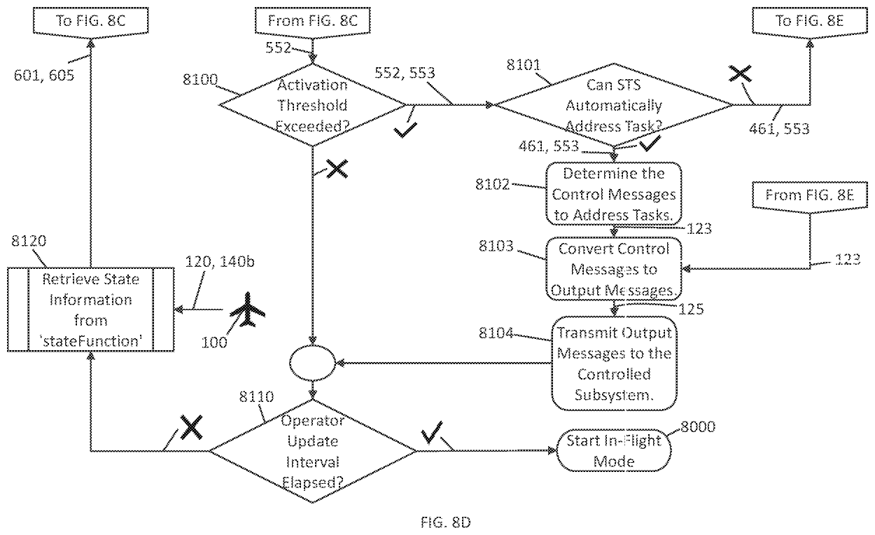

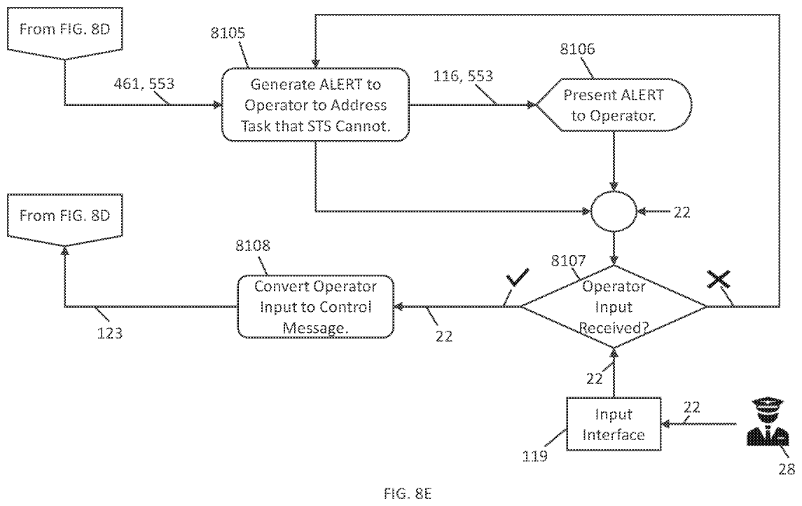

In an exemplary embodiment of an aircraft 100 as the controlled system 100, the active mode of operation of the STS 10 represents the In-Flight mode. With reference to FIG. 8, including 8A, 8B, 8C, 8D, and 8E, the In-Flight mode is characterized by the series of software tasks 8000 outlined below. It should be noted that the tasks 461 are generally implemented and executed by a combination of the CPU 106, RAM 109, and the HPC module 124 of a central computer 103 in a time sequential manner, however, one or many of the tasks 461 can be executed in parallel on multiple distributed computer-based systems that are in communication, on cloud applications, or on any platform configured to execute software applications 8000 via a CPU 106 with RAM 109 or the HPC module 124. The tasks 461 executed are based on the type of input 22, 23, 24, 120, 140b from the operator 28, passengers and crew 21, system administrators 104, situational awareness subsystems 130, and the controlled system 100 subsystems 140 as well as the multitude of states of the aircraft 100 and the application. All changes to the STS 10, including inputs 22, 23, 24, 120, 140b, states, control information 123, 125, graphical information 116, and other information should be assumed to be logged with a timestamp for later usage and AI trained model 30 refinement, even if not explicitly mentioned.

Task 8000: Start In-Flight mode of operation for STS 10.

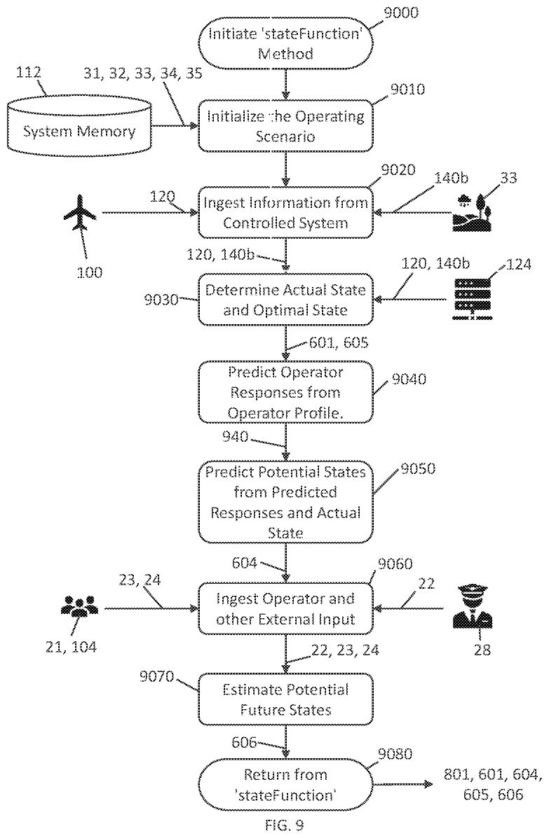

Task 8010: Retrieve information about actual state 601, predicted states 604, optimal state 605, and estimated state 606 from the ‘stateFunction’ method, later discussed in FIG. 9. Present 8011 actual state 601, predicted states 604, optimal states 605, and estimated states 606 to the operator 28 via graphical information 116 on the output terminal 115. Generate state report 801 from the generated state information with an associated timestamp.

Task 8020: Determine if operator input 22 has been received. If ‘NO’, go to task 8021. If ‘YES’, go to task 8022. Log operator input 22, including a lack of input 22 in an operator input report 802.

Task 8021: Set the most likely predicted state 604 as the FINAL estimated state 606. Generate associated control information messages 123. Alternatively, the STS 10 can be configured to set the predicted state 604 that most closely aligns with the optimal state as the FINAL estimated state 606. Continue to task 8030.

Task 8022: Ingest operator input 22 to determine the FINAL estimated state 606 via the input module 118. Convert operator input 22 into associated control information messages 123. Continue to task 8030.

Task 8030: Convert FINAL estimated state 606 control information messages 123 into a set of controlled subsystem messages 125 via the output module 121.

Task 8040: Update controlled system 100 subsystems 140 with the messages 125 via the output interface 122 to the controlled component interface 140a. Log all output messages 125 with appropriate timestamp.

Task 8041: Present updated controlled system 100 and subsystem 140 state information, as well as controlled system 100 state information 601, 604, 605, 606 to the operator 28 via graphical information 116 on the output terminal 115.

Task 8050: After a predetermined wait time, determine if the operator 28 has provided input 22. If ‘NO’, continue to task 8060. If ‘YES’, continue to task 8052. Log the operator input 22 in the operator input report 802 with an associated timestamp. The wait time is set by the system administrator 104 and can be changed during operation through operator input 22.

Task 8060: Compare estimated state 606 information to actual state 601 information and optimal state 605 information to generate comparison data 451. Comparison data 451 exceeding the operational thresholds 431 are flagged. Aggregate flagged comparison data 451 onto a comparison data report 452 with an associated timestamp. The operational thresholds 431 are initially set by the system administrator 104 based on operational profiles 31 and controlled system component profiles 34.

Task 8070: Create a set of tasks 461 based on comparison data 451 in the comparison data report 452. The created set of tasks 461 are those that would bring the actual state 601 and the estimated state 606 into alignment with the optimal state 605.

Task 8080: Aggregate tasks 461 to a task list 462. Log the task list 462 in a task list report 803 with an associated timestamp.

Task 8081: Present task list 462 to the operator via graphical information 116 on the output terminal 115.

Task 8090: Assess the comparison data 451 associated with the tasks 461 in the task list 462 to determine if the comparison data 451 exceeds an activation threshold 551, thereby creating an activation message 552. The activation thresholds 551 can be provided by the system administrator 104 prior to startup. Alternatively, the initial activation thresholds 551 can be determined from past operational profiles 31 and controlled system component profiles 34.

Task 8100: Flag 553 tasks 461 where the comparison data 451 exceeds the activation threshold 551. If activation thresholds 551 have “not” been exceeded, continue to task 8110. If activation thresholds 551 have been exceeded, continue to task 8101. Log all activation messages 552 and activation flags 553 with the associated tasks 461 in the task list report 803 with the associated comparison data 451 and an associated timestamp.

Task 8101: Determine if the STS 10 can automatically address tasks 461 where the activation flag 553 has been set. If ‘YES’, continue to task 8102. If ‘NO’, continue to task 8105. Log the determination with the associated task 461 in the task list report 803.

Task 8102: Determine the appropriate control information messages 123 based on the tasks 461 where the activation flag 553 has been set.

Task 8103: Convert the control information messages 123 into output control messages 125 via the output module 121.

Task 8104: Transmit and update the output control messages 125 via the output interface 122 to the controlled subsystem interface 140a. Go to task 8110.

Task 8105: Generate a graphical information 116 ALERT to be presented to the operator 28 via the output terminal 115 or audio alert to inform the operator 28 to provide input 22 to address tasks 461 where the activation flag 553 has been set.

Task 8106: Present the alert to the operator 28 via graphical information 116 on the output terminal 115.

Task 8107: Determine if operator input 22 has been received via the input interface 119. If ‘NO’, return to task 8105. If ‘YES’, continue to task 8108. Log the operator input 22, or lack of input, in the operator input report 802 and the task list report 803 with an associated timestamp. The interval upon which the operator 28 is alerted between task 8105, 8016, and 8107 is between about 1 s and about 5 s.

Task 8108: Convert the operator input 22 via the input interface 119 into appropriate control information messages 123. Return to task 8103.

Task 8110: Determine if an operator 28 update interval has elapsed. If ‘YES’, return to task 8000. The update interval is set to about 1 s by default but can be configured by operator input 22 or by a system administrator 104.

Task 8120: Retrieve information about actual state 601, predicted states 604, optimal state 605, and estimated state 606 from the ‘stateFunction’ method, later discussed in FIG. 9. Log the states in the state report 801 with an associated timestamp.

Task 8130: Compare actual state 601 information to optimal state 605 information to generate updated comparison data 451. Aggregate flagged comparison data 451 onto a comparison data report 452.

Task 8140: Determine if actual state 601 information is converging to optimal state 605 information. If ‘YES’, go to task 8070. If ‘NO’, go to task 8150.

Task 8150: Automatically adjust current control information messages 123 by up to about 2% of the current setting in a direction that would lead to convergence between the actual state 601, or the estimated state 606, and the optimal state 605. Convert the control information messages 123 into output control messages 125 and transmit to the controlled subsystem interface 140a where appropriate. Go to task 8040.

The main In-Flight mode of operation relies on the ‘stateFunction’, as identified in tasks 8010 and 8120 above. The ‘stateFunction’ can be characterized with reference to FIG. 9.

Task 9000: Initiate the method, ‘stateFunction’, for determining the various states of the controlled system 100, including the actual state 601, predicted state 604, the optimal state 605, and the estimated states 606.

Task 9010: Initialize the operating environment with the AI trained models 30, operational profiles 31, operator profile 32, flight profiles 33, controlled system component operational models 34, and environmental models 35.

Task 9020: Ingest information messages 120, 140 from the controlled system 100 and subsystems 140 and the situational awareness subsystems 130 via the input module 118 through the input interface 119. The controlled subsystems 140 can include but are not limited to electronic and hydraulic landing gear 141, environmental systems 142, flight management system 143, powerplant system 144, or other systems 149 required for proper operation of the aircraft 100. The situational awareness subsystems 130 can include but are not limited to weather information 131, Global Positioning System information 132, radar information, 133, satellite information 134, air data computer systems 135, additional data links 136, and potential future system 139.

Task 9030: Use HPC module 124 to determine the actual state 601 from situational awareness information messages 120 and the controlled system component information messages 140b, and the optimal state 605 of the controlled system 100 based on operational profiles 31, and flight profiles 33 from experienced operators 28. Log the actual state 601 and the optimal state 605 in the state report 801 with an associated timestamp.

Task 9040: Using the operator profile model 32 including operator 28 experience level and operational tendencies, the STS 10 predicts a set of predicted operator responses 940 and logs the predicted operator responses 940 in the operator input report 802 labeled as ‘predicted response’. Use predicted operator responses 940 to predict a set of predicted states 604, including a most likely predicted state 604. Store responses 940 and the associated states in a state report 801 with an associated timestamp.

Task 9050: Use predicted operator responses 940, and actual state 601 to predict a set of predicted states 604, including a most likely predicted state 604 on the HPC module 124. Log predicted states 604 in the state report 801 with associated timestamps.

Task 9060: Ingest operator input 22 and other external input, including from passengers and crew 21, or system administrators 104, if present through the input module 118 via the input interface 119.

Task 9070: Use the HPC Module 124 to estimate a set of the future states of the controlled system 100, thereby providing a set of estimated states 606. Log estimated states 606 in state report 801.

Task 9080: Return from the ‘stateFunction’ with the state information report 801, including information indicative of the actual state 601, predicted states 604, optimal state 605, and the estimated states 606.

During the process flows outlined in FIGS. 2-9, several reports were generated by the STS 10, containing relevant information. The reports that were generated include the comparison data report 452, the state report 801, the operator input report 802, and the task list report 803, which includes the concatenated task lists 462. Each report includes operational information that is used to update and maintain the AI trained models 30 that are used by the HPC module 124 to generate state information in the state report 801, as well as to make control information message 123 conversions and determinations for the STS 10 to automatically execute tasks 461 during STS 10 operation. Furthermore, the information in the reports can be used to generate and refine an operator's 28 operator profile 32, as well as predict potential operator responses 940 of the operator 28 during controlled system 100 operation in response to the actual state 801. Utilizing this information, the performance of an operator 28 can be assessed by system administrators 104, or expert operators 28 and instructors to identify areas of training needs, such that the STS 10 can generate a training report 1107 with recommendations for addressing errors or gaps in operational profiles 31 that occurred when an operator 28 was operating the controlled system 100. It should be noted that each information entry in each report includes an associated timestamp. With each timestamp, a trendline, or a timed profile for each operational parameter can be generated and assessed against other similar profiles.

The information provided in the comparison data report 452 includes data points that are generated when optimal state 605 information is compared against the actual state 601 information. The information provided in the comparison data report 452 is used as the basis for generating task lists 462 and task list reports 803, identifying areas for improvement in operational profiles 31 or flight profiles 33, and aligning areas for improvement to operator profiles 32 including assessing types and timestamps of operator inputs 22 and predicted operator inputs 940 found in the operator input report 802.

The information provided by the state report 801 can include information about each of the states that are generated by the operational STS 10. This includes the actual states 601 that are determined using information messages 120, 140b that are collected from the situational awareness components 130 and the controlled system components 140. Predicted states 604 can be generated starting with actual states 601 and applying a set of predicted operator inputs 940 based on the experience level or other operational tendencies found in the operator's 28 operator profile 32. Optimal states 605 can be extracted from flight profiles 33 of experienced operators 28 and saved in the state report 801 for direct comparison with the actual state 601, predicted state 604, and estimated state 606. Estimated states 606 are generated using the actual states 601 as the basis and then applying the actual operator input 22 to estimate what the future state will be.

The operator input report 802 includes the type and timestamp of the operator input 22, predicted operator input 940, or input from other human-in-the-loop components, such as passengers and crew 21, or system administrators 104, that were active during the operational profile 31.

The task list report 803 includes the snapshots of the tasks 461 and task lists 462 with associated timestamps that were generated during the execution of an operational profile 31.

Throughout the in-flight mode, the STS 10 continuously assesses the gaps between the actual state 601, the estimated state 606, and the optimal state 605 as discussed in tasks 8060 and 8130. Differences, or gaps, between the states are found in the comparison data report 452 and are flagged 553 by the STS 10 as a task 461 in the task list 462 that requires immediate action when the difference is determined to exceed the activation threshold 551. The STS 10 can assess the comparison data report 452 with the associated flagged 553 data, assess the corresponding task list 462, and determine which tasks 461 align with optimized flight profiles 33 generated by operators 28 having more experience. A difference task list that represents the gaps or differences between the task list 462 associated with the actual state and the task list 462 that was generated during the optimized flight profile 33 can be generated to assist the operator 28 in achieving the optimized state 605. Additionally, the STS 10 can assess the measured values associated with each of the controlled system components 130, 140 against the measured values of the components in the optimized flight profile 33 to prioritize the task list 462 to the operator 28. The prioritized task list 462 can then be displayed on the output terminal 115 for the operator 28 to observe and take action.

With each iteration of the process flow in FIGS. 8A thru 8E, the task list 462 is updated by the application in the HPC module 124, based on artificial intelligence, machine learning, or deep learning. The STS 10 utilizes the AI trained models 30 generated by past operational profiles 31 and flight profiles 33 from more experienced operators 28 to determine the optimal state 605 of the controlled system 100. Then, comparison data 451 in the comparison data report 452 between the optimal state 605 and the estimated state 606 or actual state 601 that exceeds the activation threshold 551 gets aggregated into a gap list. The gap list gets converted into an actionable task list 462 to present to the operator 28 via graphical information 116 on the output terminal 115.

It should be noted that the operator 28 can select either the actual state 601 or the estimated state 606 to compare against the optimal state 605 for generating the comparison data 451. Furthermore, the tasks 461 that are presented to the operator 28 can include an associated predicted state 604 that will result if the operator 28 addresses the associated task 461. Additionally, the operator 28 can select to have the STS 10 address some of the tasks 461 on the task list 462 automatically. Lastly, the operator 28 can ignore the tasks 461, thereby deferring to the STS 10 to automatically intervene and address tasks 461 on behalf of the operator 28 when the activation threshold 551 is exceeded. In all cases, the operator response 22, including the absence of a response is tracked in the operator input report 802 for updating and refining the operator profile 32.

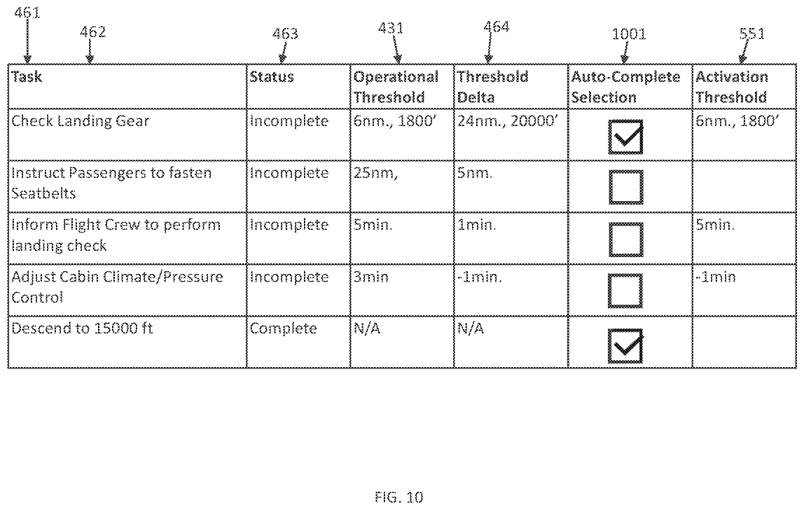

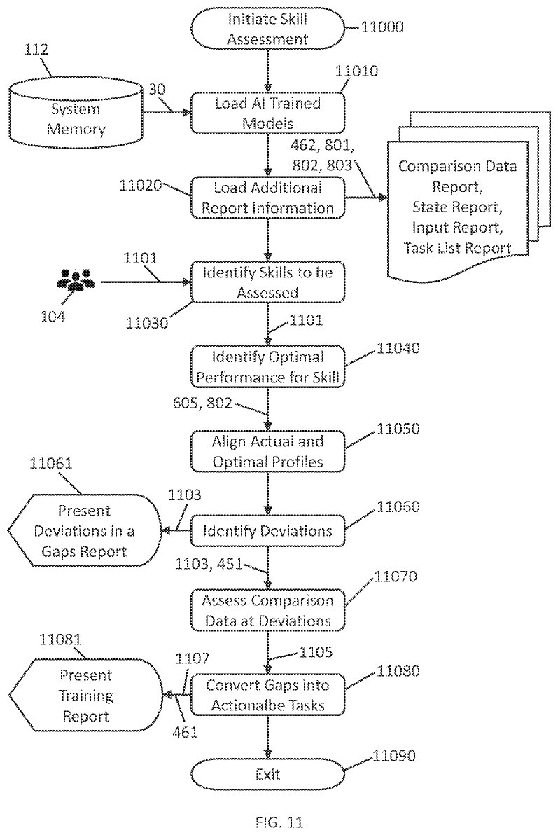

FIG. 10 shows an exemplary embodiment of an aircraft 100 in the in-flight mode of operation in which a concatenated task list 462 is generated and presented to an operator 28 via the output terminal 115. As shown, the task list 462 presents an example set of tasks 461 that the operator 28 is required to address prior to the approach of an aircraft 100 in the landing phase of flight. As shown, the task list 462 can include associated tasks 461, task status 463, operational threshold 431, threshold delta 464, a selector box 1001 for autocompletion, and an activation threshold 551. The operational thresholds 431 and activation thresholds 551 can be derived from many sources, including, but not limited to directives from air traffic control 157, defined based on safety or policy requirements, or standard operating procedures of the aircraft or controlled system 100. The operational thresholds 431 and the activation thresholds 451 are configured by the system administrator 104.

With each iteration of the process flow of FIGS. 8A-8E, the STS 10 tracks and updates the task status 463 of each task 461, thus providing feedback to the operator 28 for determining when to address each task 461, or to allow the STS 10 to automatically address each task 461. The STS 10 will automatically address tasks 461 that the operator 28 ignores. For any tasks 461 that the STS 10 cannot automatically address, the STS 10 generates an alert to the operator 28, as discussed in task 8105. The alert message can be an audio alarm, a blinking light, or an equivalent means to gain the attention of the operator 28. In all cases, the operator inputs 22, including lack of input, are tracked by the STS 10 and used for trained operator profile 32 refinement. All task list 462 snapshots are saved in the task list report 803 with appropriate timestamps and linked to associated operational profiles 31 and flight profiles 33. As such, the saved task list reports 803 can later be referenced as needed for identifying areas of needed training or to provide examples of near optimal flight profiles 33.

The task list 462 is generated by the STS 10 on the HPC module 124 that is executing AI applications based on machine learning or deep learning algorithms. The controlled system 100 AI trained models 30 are generated using flight profiles 33 from past flights by more experienced operators 28 on similar controlled systems 100 as the input training data. The STS 10 can also be configured to use the operational tendencies of the operator 28 from the operator profile 32 as an additional input training data.

During the in-flight mode of operation, an operator 28 is logged into the STS 10. The STS 10 automatically loads the operator profile 32 on controlled system 100 startup, as shown with reference to FIGS. 2-9. During execution of the in-flight mode of operation, the operator 28 is continuously presented with operational scenarios 541 in real time, where operational profiles 31 and flight profiles 33 are established. Additionally, the operator 28 interfaces continuously with the controlled system 100 via the input interface 119, providing operator input 22 to control the controlled system 100. The operator inputs 22 provided are associated with timestamps within the current operational profile 31 and the current flight profile 33. Typically, the operator inputs 22 are provided in response to an event, such as an alert from the STS 10 on the output terminal 115, or in response to a directive from air traffic control 157. The operator inputs 22 are captured in the operator input report 802, are saved to the operator profile 32 and associated with the corresponding operational profile 31 and flight profile 33 for use in an instructional mode of operation where operator 28 operational tendencies and behavior is assessed for predictive responses 940, training gaps, or to establish a training program.

In the instructional mode of operation, the STS 10 can use the information in the comparison data reports 452, state reports 801, operator input reports 802, task list reports 803, as well as the AI trained models 30 to assess operator 28 performance during a given operational scenario 541. The operational profiles 31 can be assessed against the operator 28 experience level or against the flight profiles 33 where the associated operator 28 was interfacing with the controlled system 100. Tasks 461 that were not correctly executed, or not executed at all, by the operator 28 can be flagged as either an erroneous action, or as a potential gap in experience.

During the in-flight mode of operation, the STS 10 continuously logs information in time sequence about the state of the controlled system 100, its environment, and the operator responses 22. The information logged includes but is not limited to the following: situational awareness information messages 120, task lists 462, operator responses 22, aircraft actual state 601, aircraft controlled system information messages 140b, crew and passenger inputs 23, and external directives from ATC 157.

The operational scenario 541 information includes general information about the flight profile 33. The data that can include but is not limited to altitude, GPS location 132, data link information including type of flight, departure airport, arrival airport, time of day, bearing, and weather 131, by use of example.

The operator responses 22 include information that is captured through the input interface 119 and indicates how the operator 28 responded to various situations in a time sequence, as shown in FIG. 7. The data that is captured can include but is not limited to: appropriate operation of landing gear 141, response to weather 131, response to directive from air-traffic control 157, response to loss of communications 145, response to aircraft 100 state on landing or takeoff found in controlled system component information messages 140b, response to input from crew or passengers 21, and response to cabin environment 142, by use of example.

The aircraft actual state 601 includes information that indicates how the aircraft 100 is operating in a time sequence. The data that is captured can include but is not limited to: state of the landing gear 141, state of the engines, state of the wings and flight equipment as it pertains to pitch, roll, and yaw from the flight management system 143, state of the powerplant 144, and state of the fuel, by use of example.

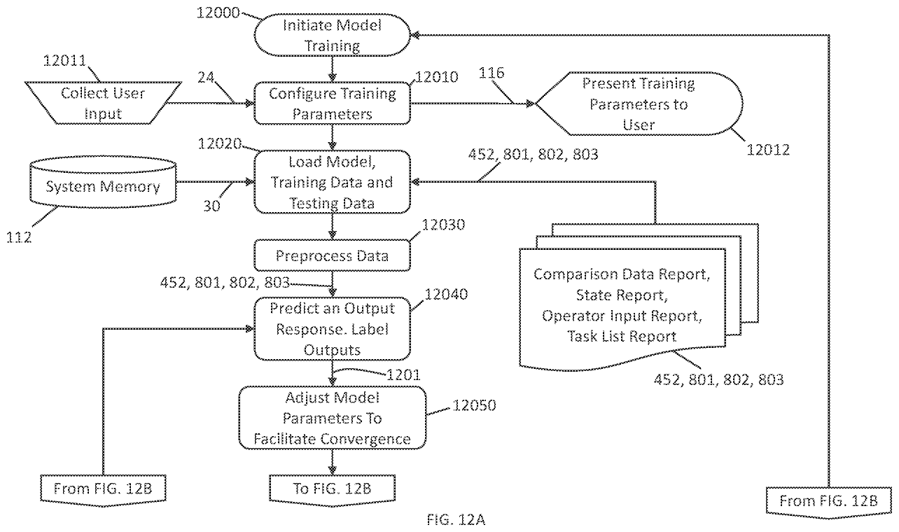

During the assessment of operator 28 skill, the STS 10 can be configured to assess any of the streams of data in time against the performance of the operator 28, namely, through the assessment of the operational profile 31 of any of the controlled system 100 or subsystems 140. The assessment of operator 28 skill is performed by the process flow shown in FIG. 11.

Task 11000: Initiate skill assessment.

Task 11010: Load AI trained models 30, including operator profile 32, operational profiles 31, and flight profiles 33 from system memory 112 into RAM 109 and the HPC module 124.

Task 11020: Load additional reports, including comparison data reports 452, state reports 801, operator input reports 802, and task list reports 803, into RAM 109 from system memory 112.

Task 11030: Identify skill 1101 to be assessed by the system administrator 104 or instructor.

Task 11040: Select an optimal state 605 operational profile 31 of a skill 1101 to be assessed from a set of available operational profiles 31 available on in system memory 112.

Task 11050: Align optimal state 605 operational profile 31 with actual state 601 operational profile 31 and operator input report 802 information, as operated by the operator 28. Develop a timeline to assess the optimal state 605 vs. the actual state 601.

Task 11060: Identify timestamps on the timeline where actual state 601 operational profile 31 deviates from optimal state 605 operational profile 31 in a gap report 1103. Store gaps report 1103 in system memory 112.

Task 11061: Present gaps report 1103 to system administrator 104 and operator 28 via output terminal 115.

Task 11070: Assess comparison data 451 in comparison data report 452 at the associated timestamps in gaps report 1103 to identify operational gaps 1105.

Task 11080: Convert gaps 1105 in gaps report 1103 into actionable operational tasks 461. Aggregate actionable tasks 461 into a training report 1107.

Task 11081: Present training report 1107 to instructor and operator 28. Store training report 1107 in system memory 112.

Task 11090: Exit.

The training report 1107 includes a full report on the operational gaps 1105 between the optimal state 605 flight profiles 33 and the actual state 601 flight profiles 33, as well as a predefined sequence of steps, as defined from the flight profiles 33 of more experienced operators 28 in similar operational scenarios 541, the operator 28 should focus on during training sessions. During operation, the sequence of steps, as defined, can provide for the training of the operator 28 to interface with the controlled system 100 during an operational scenario 541 in a manner which addresses the associated operational gap 1105. The training report 1107 will include each operational gap 1105 and the associated sequence of steps aimed at improving the operational behavior of the operator 28. The sequence of steps may include direct instructions to the operator 28, for example, instructing the operator 28 to lower the landing gear 141 at an earlier time or at a greater distance from the runway in the embodiment where an aircraft is the controlled system 100. The sequence of steps is captured directly from the operational profiles 31 of more experienced operators 28 and will identify actions taken by those operators during the optimal state 605 flight profile 33. The sequence of steps can include an optimized task list 462 that communicates the actions taken by more experienced operators 28 to address the operational gaps, where the optimized task list 462 represents the optimized operational profile 31 of aircraft 100 in an operating scenario 541.

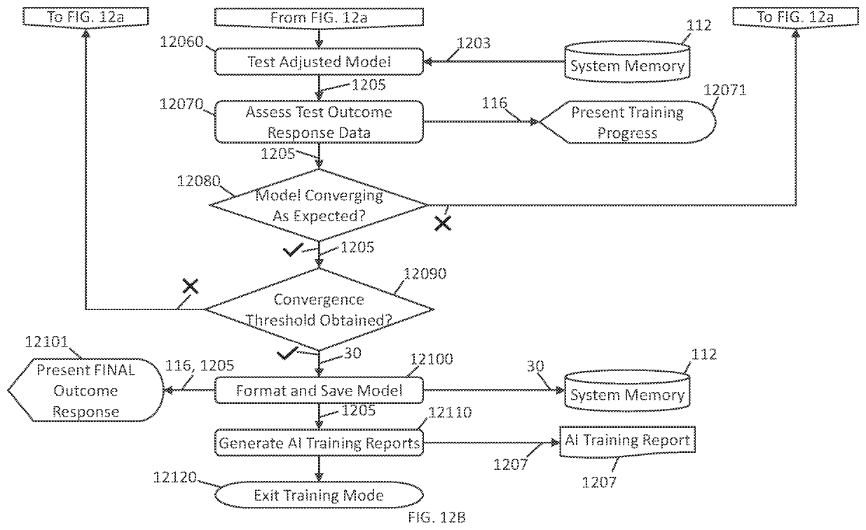

The STS 10, based on machine learning or deep learning, includes a training mode of operation as shown in FIG. 12, including FIGS. 12A and 12B. In the field of AI, training is the process by which an AI trained model 30 “learns” how to predict an output response 1201 based on the input data. In the exemplary embodiment of an aircraft 100, the input data is derived from the comparison data report 452, the state report 801, the operator input report 802, and the task list report 803. Additional input can include an AI trained model 30 in cases where a previously trained model 30 is being updated. It should be noted that the training mode of operation in the field of AI is typically known to one of ordinary skill in the art. As shown in FIG. 12, including FIGS. 12A and 12B, a high-level operational flow of the training process is covered in the following steps.

Task 12000: Initiate AI trained model 30 training method.

Task 12010: Configure the training parameters. Collect 12011 system administrator input 24 or other user input to adjust the configuration parameters via the input interface 119, including the AI trained model 30 to be updated. Present 12012 the initial training parameters back to the system administrator 104 or user via the output terminal 115 for verification.

Task 12020: The AI model 30 to be trained as well as the training and testing data found in the reports 452, 801, 802, 803 is loaded into RAM 109 or the HPC module 124.

Task 12030: Preprocess data by an appropriate preprocessing algorithm, as determined by the system administrator 104. For example, the data may include known erroneous timestamps, or be in an unreadable format.

Task 12040: Predict an output response 1201 based on training input data from reports 452, 802, and labeled outcome response data found in the state report 801 and the task list report 803.

Task 12050: Adjust model 30 parameters towards optimization based on an objective response vs predicted output response 1201 found in the state data report 801 and the task list report 803. For example, during a landing approach, the airspeed should be in the range of about 175 knots to about 200 knots, which can be a known objective response. Optimization indicates that the AI trained model 30 can process the information message to predict an airspeed in this acceptable range. This same philosophy can be applied to each of the operational controlled system components 140 and operating parameters.

Task 12060: Test adjusted model 30 on test data 1203.

Task 12070: Assess test outcome response data 1205 for accuracy and convergence. Present 12071 training progress to system administrator 104 via the output terminal 115.

Task 12080: Determine if the model 30 is converging to the objective response. If ‘NO’, return to 12000. If ‘YES’, continue to 12090.

Task 12090: Determine if the model 30 has converged to convergence threshold as defined by the operational parameters of the controlled system 100. If ‘NO’, continue training at 12040. If ‘YES’, continue to 12100.

Task 12100: Present 12101 the outcome response data 1205 in graphical information 116 a format to system administrator 104 via output terminal 115. Store AI trained model 30 in system memory 112.

Task 12110: Generate AI train reports 1207.

Task 12120: Exit model training mode of operation.

For the training process, several parameters can be controlled by the system administrator 104 with the intent on having an influence on the resulting trained model 30. Some of the controllable parameters can be adjusted by system administrator input 24, and include but are not limited to the type of training to be performed, the optimization function or the cost function, the training data from reports 452, 801, 802, 803, the test data 1203, the verification data, the model 30 to be trained, the initial conditions, and rate of convergence. In an exemplary embodiment, the controllable parameters can align with flight profiles 33 or operator profiles 32 that focus on capturing information indicative of different scenarios, operators 28 of different levels of skill and experience, state variation over time, adherence to policies and procedures, responses to new components 130, 140, such as landing gear position, or the like.

A variety of flight profiles 33 and operator profiles 32 of different skill and experience levels can be generated. The task lists 462 can be used as input to each of these models 30 to define a set of initial conditions or as case studies for training experiments or laboratory trials when the safety and operability of a new controlled system component 140 or situational awareness subsystem 130 is being adapted for use in an aircraft 100. In an educational setting, the task lists 462 can be used in combination with flight profiles 33 and operator profiles 32 to create simulations, short courses, or training sessions with the intent to improve specific skills of an operator 28. The operational model 31 exposes the human operator 28 to a variety of states, including actual states 601, optimal states 605, and undesirable states based on training needs. The task list 462 can provide further guidance to the operator 28 for providing additional input 22 when needed. The STS 10 tracks the operators' responses 22, appropriately labeling them and using them to update the operator profile 32. The STS 10 can reuse this information in the operator profile 32 to make training recommendations to the operator 28 in the in-flight mode of operation.

The aircraft 100 operational models 31, which may be considered as an aggregation of interactive controlled system component models 34, can show the estimated state 606 of aircraft components 130, 140 as a function of time with an optimal state 605 as the baseline. These models 34 can provide input to the AI trained model 30 for generating the task list 462 as the in-flight mode executes. The STS 10 can be configured to update the task list 462 based on learned optimal states 605 or flight profiles 33, or if information in the actual state 601 and/or estimated states 606 deviates from the acceptable operational thresholds 431 of the optimal state 605 during controlled system 100 operation.

The STS 10 includes an administrative mode that enables a system administrator 104 to provide input 24 to the STS 10. In this case, past task lists 462 with violations can be customized as input to alter the intended outcome of the instructional session or to provide further guidance to the operator 28 of the aircraft 100. As aircraft operational models 31, including controlled component models 34, and past flight profiles 33 are combined, instructors or the operators 28 themselves can set the development goals from past operational profiles by the operator 28. The goals can be manually delivered to the STS 10 as system administrator input 24 to influence a training simulation in such a way that affective, cognitive, or psychomotor skills can be developed to yield specific results from the operator training.

In view of the above, it will be seen that the several advantages of the present disclosure have been achieved and other advantageous results have been obtained over the prior art. The STS 10 that continues to operate with a human in the loop is configured to track the human interaction and learn the responses to a variety of operating scenarios 541. Due to the adaptable nature, they are becoming popular in many industries, including but not limited to financial, aircraft/airlines, health care, nuclear power, marine, and defense.

As previously described in an exemplary embodiment of an aircraft 100, the STS 10 can implement operational profiles 31 or flight profiles 33 as a simulated operating scenario 541, in which an operator 28 provides responses 22 back to the STS 10. The responses 22 can be tracked and logged in an operator profile 32, which is indicative of the operator's 28 level of experience or skill on particular tasks.

The STS 10 is configured to implement learned models for operator profiles 32 and then use the tracked operator responses 22 to refine the operator profiles 32. From the operator profiles 32, the STS 10, an instructor, or a system administrator 104 can analyze the operator profile 32 to predict how the operator 28 would respond in a specific operational scenario 541, generate a list of predicted responses 940, and then generate a list of predicted states 604. This information can be used in a variety of ways, including flight profile 33 refinement and training, predicting how an operator 28 may respond to given situations, and to develop a training curriculum for the operator 28 to refine skills to particular tasks 461.

As various changes could be made in the above constructions without departing from the scope of the disclosure, it is intended that all matter contained in the above description or shown in the accompanying drawings shall be interpreted as illustrative and not in a limiting sense.

1. A control system for managing the operational tasks of a controlled system having an controlled interface module for receiving and transmitting information with the controlled system, a human interface module for receiving inputs from a human operator, a communications module for communicating information with a human operator, a processor module, a system memory module for storing computer executable instructions, a memory module for random access memory (RAM) storage during system operation, a high performance computing (HPC) module, the processor module configured for processing of computer executable instructions configured to facilitate the flow of information between the controlled system, the operator, the system memory module, the RAM, and the HPC module, the control system comprising:
an input for receiving at least one operational status message containing an operational parameter having one or more operational parameter values representative of the actual state of an operation of the controlled system from at least one of the controlled system components of the controlled system during operation thereof, and for processing the received operational parameter and the one or more operational parameter values to determine a current observed state of the controlled system or controlled component of the system;
at least one operational model of the controlled system stored in the system memory module, each at least one operational model including a plurality of predetermined objective operational parameters associated with one or more operational components of the controlled system and having at least one objective parameter value for one or more of the plurality of the predetermined operational parameters;
the processor configured to access the memory and retrieve the at least one operational model, and to determine an optimal state of the controlled system or controlled system component as a function of the retrieved operational profile and the received operational status message, the observed state and the optimal state of the controlled system each including a plurality of operational components, the actual state information and optimal state information operational components having a corresponding match, and the operational components having an associated measured operational value representing the state of the operational component; and
upon determining said observed state information of the controlled system and determining the optimal state of the controlled system, to determine a set of gaps between corresponding components of the observed state and the determined optimal state of the controlled system, said determined gaps including an associated value representing the magnitude of the difference between the observed state and the optimal state, and collecting the determined gaps in a gap list that represents the differences between the observed state and the optimal state of the controlled system; retrieving from the memory one or more stored operational thresholds associated with the determined gaps and that correspond to one or more of the controlled components of the controlled system, wherein the retrieved operational thresholds are indicative of an acceptable range of difference values between the matched controlled components of the observed state and the determined optimal state;
comparing the associated difference values of the determined gaps with the received operational thresholds for the associated controlled component; and
providing an alert to the human operator when the comparing of the associated difference values of the determined gaps exceed the received operational threshold for one or more of the associated controlled components.

2. The control system of claim 1, wherein the system is further configured to communicate said gap list to the operator of the controlled system via the communication module.

3. The control system of claim 2; wherein each operational model includes one or more operational profiles indicative of past optimized operational profiles, and a set of operational tasks that had previously been executed associated with said optimized operational profiles.

4. The control system of claim 3, wherein the system is configured to generate an optimized task list associated with the past optimized operational profiles.

5. The control system of claim 4, the system further configured to convert the gap list into an actual task list;
to compare the actual task list to the optimized task list; and
to determine a difference task list as a function of the comparison of the actual task list to the optimized task list.

6. The control system of claim 5, the system further being configured:
to prioritize the tasks within the difference task list; and
to create a prioritized task list from the prioritized tasks, with the created prioritized task list to align the observed state of the controlled system closer with the optimal state of the controlled system.

7. The control system of claim 6, wherein the communication module further comprises an output terminal configured to present the prioritized task list to the human operator of the controlled system via the output terminal.

8. The control system of claim 1, the system further configured to convert the determined gaps on the gap list into a set of tasks on a task list;
wherein, when the difference values exceed the operational threshold associated with a task, the system being configured to determine whether the associated tasks on said task list can be automatically addressed by the system or the associated tasks must be presented to the human operator for human operator input response.

9. The control system of claim 8, the system further comprising an output terminal;
wherein if said system cannot address said tasks on said task list, the system is configured to provide an alert over the output terminal to said human operator on a continuous interval.

10. The control system of claim 9 wherein said continuous interval is in a range between about 1 s and about 5 s.

11. The control system of claim 8, further comprising:
the system configured for storing a set of activation thresholds associated with said gaps corresponding to said components of said controlled system, said activation thresholds representing a maximum acceptable difference value between said matched components of said observed state information and said optimal state information;
wherein when said difference values exceed said activation thresholds, the system being configured to automatically generate a set of determined control messages to one or more controlled components of the controlled system until the difference value between said matched components is reduced below a predetermined difference value.

12. A control system for assisting a human operator with operational task execution of a controlled system with a plurality of controlled components, the system having a human interface module for receiving and communicating with a human operator, a memory module for storing artificial computer executable instructions, a processor module configured for processing of computer executable instructions for managing the system controlled information, an HPC module for complex computational processing, a controlled system interface module for receiving and transmitting information messages to the controlled components of the controlled system, the control system comprising:
an operational model of the controlled system stored in said memory module, said operational model including information that represents a plurality of component operational models matched to said plurality of controlled components, said information configured to generate modeled operational behavior of said components with a generated value indicative of the modeled observed state of said components upon receipt of input information messages containing one or more values for one or more operational parameters of an actual state of one or more controlled components of the controlled system via said controlled system interface module, said modeled operational components collectively modeling the operation of said controlled system;
the processing module configured with computer executable instructions for determining observed state information of the controlled system or one or more controlled components thereof, wherein the observed state information includes measured values indicative of an actual state of the controlled components of the controlled system, the processor further configured for receiving an operator profile from the memory of the operator's operational behaviors and operational tendencies, predicting one or more operator inputs as a function of the observed state and the stored operator profile including one or more operational behaviors and tendencies, determining a predicted state model of the controlled system, including a most likely predicted state thereof, the determining of the predicted state model being a function of the determined observed state as the initial state, the predicted one or more operator input and the plurality of component operational models, the determined predicted state model including a plurality of determined predicted states as a function of the predicted operator inputs, wherein each predicted state model includes a most likely predicted state.

13. The control system of claim 12, the system further comprising an output terminal;
wherein, upon determining the predicted state model, including the most likely predicted state, the processor further configured to generate a presentation of at least some or all of said predicted state model to the operator via the output terminal.

14. The control system of claim 13, wherein, following the generation and the presentation of said the predicted state model to the operator, the processor is configured to generate one or more prompt predicted states as options to the operator from which the operator can select one of said predicted states as an objective state.

15. The control system of claim 14, the system further configured to receive a selection by the operator of one of the prompted predicted states, and in response, the processor being configured to automatically adjust the controlled system component inputs to the received selected state.

16. The control system of claim 14, wherein, in response to the generation of the one or more prompts to the operator, if the system does not receive an operator selection within a predetermined operator response time, the system is configured to automatically select the most likely predicted state as an objective state, and to automatically generate one or more control messages to one or more controlled components as a function of the difference between the observed state and the objective state.

17. The control system of claim 14, the system further being configured with:
a flight profile of the controlled system stored in said memory module, including operational parameters and one or more values of such parameters that represents the plurality of objective states matched to said plurality of controlled components, said operational parameters and values of the parameters including a trendline of past measured parameter values in a time sequence of measured parameter values of said controlled components, said flight profile representing a predetermined objective operational profile;
the processor configured for determining an optimal state of the controlled system, wherein said optimal state includes measured parameter values indicative of an optimal state of the controlled components of the controlled system, the controlled components collectively representing an optimal state of said controlled system; and
for determining when the operator does not select one of the plurality of generated predicted states within a predetermined time, automatically selecting the one of the plurality of predicted states that most closely aligns with the determined optimal state as an objective state, and automatically generating a control message to adjust and operation of one or more of the controlled system component until the observed state is equal to or substantially similar to the optimal state.

18. The control system of claim 12, the system further being configure with:
a flight profile of the controlled system stored in said memory module including operational parameters and values for one or more operational parameters that represents one or more optimal states matched to said plurality of controlled components, said information including a trendline of past measured operational parameter values in a time sequence of measured operational parameter values of said controlled components, said flight profile representing a fixed ideal operational profile;
the processor being further configured for determining optimal state information of the controlled system, wherein said optimal state information includes measured parameter values for one or more operational parameters that are indicative of an optimal state of the controlled components of the controlled system, the controlled components collectively representing an optimal state of said controlled system, and automatically selecting one of the plurality of predicted states that most closely aligns with the optimal state as an objective state, and automatically generating one or more control messages to one or more controlled system components for adjusting the controlled system component towards the optimal state.

19. A control method for prioritizing operational tasks associated with operating a controlled system, the method comprising:
retrieving a flight profile information from a memory module;
generating an optimal operational profile and a sequence of optimal states from said flight profile information based on sequences of states of controlled system components;
receiving operational component state information from one or more controlled components of the controlled system having operational parameters and values for operational parameters representative of an actual state of the controlled system;
determining an observed state of the controlled system based on said received operational component state information and the received flight profile information;
comparing the observed state with a sequence of the generated sequence of optimal states and identifying most likely alignment in time within the sequence;
generating a list of gaps that exist between the determined observed state and the generated optimal state;
receiving executed tasks associated with the actual state of the controlled system during the retrieving of the operational component state information;
evaluating the received tasks be in the optimal state according to the determined optimal operational profile;
determining tasks required for the controlled system to perform to reduce the gaps between the actual state and the optimal state, and aggregating the determined tasks into a task list;
establishing a measure of criticality associated with each determined task based on the observed state relative to a stored activation threshold for such a task by which the task must be completed;
generating over an output interface to an operator of the controlled system the determined task list and a task selection prompt providing the operator with selectable task options from which the operator can select as an operator task input;
monitoring the observed state or one or more operational parameter values for determining when an activation threshold is being approached;
executing one or more tasks automatically when the monitoring determines when an activation threshold is being approached; and
generating an alert to the operator over an output interface prompting the operator to provide a control input as to one or more tasks on the task list for which the control system cannot automatically generate as a function of the operational profile for the controlled system.

20. A control method of claim 19, the method further comprising the steps of:
retrieving an operator profile, including with past flight profiles as operated by an operator associated with said operator profile, the operator profile including one or more operator operational behaviors and tendencies;
predicting a set of operator input responses of the operator as a function of the operational behaviors and tendencies of the operator profile;
prioritizing the operator response inputs based on a determining for each a likelihood that the operator would provide a response input thereof; and
predicting a set of predicted states from said operator responses;
wherein the step of determining tasks required of the controlled system to address the gaps between the actual state and the optimal state, then aggregating said tasks into a task list further includes selecting one of said predicted states that most closely aligns with said optimal state;
selecting the tasks associated with the selected predicted state;
determining a measure of criticality of danger to passengers, crew, the operator, and the controlled system;
prioritizing the selected tasks associated with the selected predicted state as a function of the determined measure of criticality of danger.
